(19) United States
(12) Patent Application Publication
(10) Pub. No.: US 2023/0012091 A1
(43) Pub. Date: Jan. 12, 2023

(54) RANGEFINDER

(71) Applicant: DENSO CORPORATION, Kariya-city (JP)

(72) Inventors: Noriyuki OZAKI, Kariya-city (JP); Yoshihiro MURAKAMI, Kariya-city (JP); Takehiro HATA, Kariya-city (JP); Yoshiaki HOASHI, Kariya-city (JP); Masato NAKAJIMA, Kariya-city (JP)

(21) Appl. No.: 17/934,082

(22) Filed: Sep. 21, 2022

Related U.S. Application Data
(63) Continuation of application No. PCT/JP2021/010848, filed on Mar. 17, 2021.

(30) Foreign Application Priority Data
Mar. 24, 2020 (JP) 2020-053118
Mar. 17, 2021 (JP) 2021-043155

(51) Int. Cl. G01S 7/4865; G01S 7/484; G01S 17/10

(52) U.S. Cl. CPC G01S 7/4865; G01S 7/484; G01S 17/10

(57) ABSTRACT

A rangefinder includes a light emitting part, a light receiving part, a calculating part that calculates the distance from a reflective object, and a control part. The calculating part has a received light intensity determining part, a peak detecting part, and a distance calculating part, and a distance determining part. The control part controls at least one of the intensity of the pulsed light, the sensitivity of the light receiving part to received light, and a position of the region of interest so that a first received light intensity is obtained as the received light intensity of each of the plurality of times of flight at least once, and a second received light intensity having a higher S/N ratio is obtained as the received light intensity of each of the plurality of times of flight at least once. The distance determining part determines the measurement target distance by using the first distance based on the first received light intensity and the second distance based on the second received light intensity.

### CROSS-REFERENCE TO RELATED APPLICATION

This application is the U.S. bypass application of International Application No. PCT/JP2021/010848 filed on Mar. 17, 2021 which designated the U.S. and claims priority to Japanese Application No. 2020-053118 filed on Mar. 24, 2020, and Japanese Application No. 2021-043155 filed on Mar. 17, 2021, the contents of all of which are incorporated herein by reference.

### TECHNICAL FIELD

The present disclosure relates to a rangefinder.

### BACKGROUND

A rangefinder is known that detects the presence/absence of an object and measures the distance thereto by emitting pulsed light such as a laser beam from a light emitting part, detecting the reflected light from the object with a light receiving part, and measuring the time of flight (ToF) of the light from the emission to reception thereof (refer to JP 2016-176721 A, for example). The rangefinder emits pulsed light in various directions, measures the time of flight of the reflected light for each direction to determine the distance to an object, and generates a distance image including the position and distance of the object. Such a distance image is used, for example, to detect the position, speed, and the like of an obstacle when a vehicle is driving autonomously.

### SUMMARY

According to an aspect of the present disclosure, a rangefinder is provided. The rangefinder includes: a light emitting part that emits pulsed light a plurality of times in each emission direction; a light receiving part that receives reflected light of the pulsed light; a calculating part that uses a time of flight of the reflected light received by the light receiving part to calculate a measurement target distance, which is a distance to a reflective object that reflects the pulsed light and outputs the reflected light; and a control part that controls at least one of an intensity of the pulsed light emitted from the light receiving part, sensitivity of the light receiving part to the reflected light received, and a position of a region of interest on the light receiving part in which a received light intensity is determined. The calculating part includes a received light intensity determining part that determines a received light intensity for each of a plurality of times of flight, a peak detecting part that detects a time of flight corresponding to a peak of the received light intensities of the plurality of times of flight, a distance calculating part that calculates a distance from the detected time of flight corresponding to the peak, and a distance determining part that uses the distance calculated by the distance calculating part to determine the measurement target distance. The control part controls at least one of an intensity of the pulsed light emitted from the light emitting part, the sensitivity of the light receiving part to the reflected light received, and the position of the region of interest so that the received light intensity determining part obtains, at least once in the plurality of times the pulsed light is emitted, a first received light intensity as the received light intensity of each of the plurality of times of flight, and the received light intensity determining part obtains, at least once in the plurality of times the pulsed light is emitted, a second received light intensity having an S/N ratio higher than that of the first received light intensity as the received light intensity of each of the plurality of times of flight, and the distance determining part uses a first distance, which is the distance calculated based on the first received light intensity, and a second distance, which is the distance calculated based on the second received light intensity, to determine the measurement target distance.

### BRIEF DESCRIPTION OF THE DRAWINGS

The above features of the present disclosure will be made clearer by the following detailed description, given referring to the appended drawings. In the accompanying drawings:

FIG. 1 is a schematic configuration diagram of a rangefinder according to an embodiment of the present disclosure;

FIG. 2 is an explanatory diagram schematically showing the configuration of a light receiving array;

FIG. 3 is a circuit diagram schematically showing the configuration of a SPAR circuit;

FIG. 4 is block diagram showing the functional configuration of a rangefinder according to a first embodiment;

FIG. 5 is a flowchart showing the procedures of a rangefinding process of the first embodiment;

FIG. 6 is an explanatory diagram showing an example of how the histogram changes according to the first embodiment;

FIG. 7 is an explanatory diagram showing another example of how the histogram changes according to the first embodiment;

FIG. 8 is a flowchart of the procedures of a distance image generating process according to the first embodiment;

FIG. 9 is an explanatory diagram schematically showing how an integrated distance image is generated;

FIG. 10 is a flowchart showing the procedures of a rangefinding process of a second embodiment;

FIG. 11 is an explanatory diagram showing an example of how the histogram changes according to the second embodiment;

FIG. 12 is an explanatory diagram showing another example of how the histogram changes according to the second embodiment;

FIG. 13 is block diagram showing the functional configuration of a rangefinder according to the second embodiment;

FIG. 14 is a flowchart showing the procedures of a rangefinding process of a third embodiment;

FIG. 15 is a flowchart of the procedures of a distance image generating process according to a fourth embodiment;

FIG. 16 is an explanatory diagram showing an example of an image with flares;

FIG. 17 is an explanatory diagram showing an example of how the histogram changes according to the fourth embodiment;

FIG. 18 is an explanatory diagram showing another example of how the histogram changes according to the fourth embodiment;

FIG. 19 is an explanatory diagram showing a first distance image of the fourth embodiment;

FIG. 20 is an explanatory diagram schematically showing the configuration of a light receiving array of a fifth embodiment;

FIG. 21 is a flowchart showing the procedures of a rangefinding process of the fifth embodiment;

FIG. 22 is a flowchart showing the procedures of a rangefinding process of a sixth embodiment;

FIG. 23 is an explanatory diagram showing an example of how a histogram for a high reflection direction changes according to the sixth embodiment;

FIG. 24 is an explanatory diagram schematically showing how an integrated distance image is generated according to a seventh embodiment;

FIG. 25 is a flowchart showing the detailed procedures of step S225 according to the seventh embodiment;

FIG. 26 is a schematic configuration diagram of a rangefinder according to an eighth embodiment;

FIG. 27 is a block diagram showing a connection configuration of light emitting elements and a drive circuit according to another embodiment;

FIG. 28 is a block diagram showing a connection configuration of light emitting elements and drive circuits according to another embodiment;

FIG. 29 is a block diagram showing a connection configuration of a light emitting element and drive circuits according to another embodiment;

FIG. 30 is a block diagram showing a connection configuration of light emitting elements and a drive circuit according to another embodiment; and

FIG. 31 is an explanatory diagram schematically showing the configuration of a light receiving array according to another embodiment.

### DETAILED DESCRIPTION OF THE PREFERRED EMBODIMENTS

Generally, the pulsed light and reflected light emitted and received by the rangefinder pass through a window that transmits these rays of light. Part of the pulsed light is reflected off this window, and the reflected light is received by the light receiving part. Therefore, when the reflected light from an object located near the rangefinder and the reflected light from the window (so-called clutter) are received after emitting the pulsed light, their times of flight may be close to each other, and the accuracy of measurement of the distance to the object may decrease. Such a problem may also be caused by factors other than clutter. Specifically, when the object has a portion having a high reflectance, since the intensity of the reflected light from that portion is very high, reflected light having an intensity higher than that of the actual reflection, that is, a so-called flare may be measured from a location near that portion. In such a case, the distance of the object at the location corresponding to the flare may be erroneously measured. For these reasons, a technique is desired that can suppress the decrease in measurement accuracy due to reflected light (noise) other than the expected reflected light, such as clutter or a flare.

According to an aspect of the present disclosure, a rangefinder is provided. The rangefinder includes: a light emitting part that emits pulsed light a plurality of times in each emission direction; a light receiving part that receives reflected light of the pulsed light; a calculating part that uses a time of flight of the reflected light received by the light receiving part to calculate a measurement target distance, which is a distance to a reflective object that reflects the pulsed light and outputs the reflected light; and a control part that controls at least one of an intensity of the pulsed light emitted from the light receiving part, sensitivity of the light receiving part to the reflected light received, and a position of a region of interest on the light receiving part in which a received light intensity is determined. The calculating part includes a received light intensity determining part that determines a received light intensity for each of a plurality of times of flight, a peak detecting part that detects a time of flight corresponding to a peak of the received light intensities of the plurality of times of flight, a distance calculating part that calculates a distance from the detected time of flight corresponding to the peak, and a distance determining part that uses the distance calculated by the distance calculating part to determine the measurement target distance. The control part controls at least one of an intensity of the pulsed light emitted from the light emitting part, the sensitivity of the light receiving part to the reflected light received, and the position of the region of interest so that the received light intensity determining part obtains, at least once in the plurality of times the pulsed light is emitted, a first received light intensity as the received light intensity of each of the plurality of times of flight, and the received light intensity determining part obtains, at least once in the plurality of times the pulsed light is emitted, a second received light intensity having an S/N ratio higher than that of the first received light intensity as the received light intensity of each of the plurality of times of flight, and the distance determining part uses a first distance, which is the distance calculated based on the first received light intensity, and a second distance, which is the distance calculated based on the second received light intensity, to determine the measurement target distance.

According to the rangefinder of this aspect, the received light intensity determining part obtains, at least once in the plurality of times the pulsed light is emitted, a first received light intensity as the received light intensity of each of the plurality of times of flight, and the received light intensity determining part obtains, at least once in the plurality of times the pulsed light is emitted, a second received light intensity having an S/N ratio higher than that of the first received light intensity as the received light intensity of each of the plurality of times of flight. Further, a first distance calculated based on the first received light intensity and a second distance calculated based on the second received light intensity are used to determine the measurement target distance. Accordingly, it is possible to suppress the decrease in measurement accuracy due to reflected light (noise) other than the expected reflected light such as clutter or a flare. Generally, clutter is detected as light having an intensity lower than that of the reflected light from a reflective object (object), and the reflected light from a portion hidden by a flare can be detected as light having an intensity lower than that of the reflected light of a portion having a high reflectance in a situation in which a received light intensity having a low S/N ratio (second received light intensity) is obtained. Therefore, it is possible to generate a distance that does not include noise such as clutter or a flare as the first distance, and prevent a decrease in the accuracy of the measurement target distance determined using the first and second distances.

### A. First Embodiment

### A1. Device Configuration:

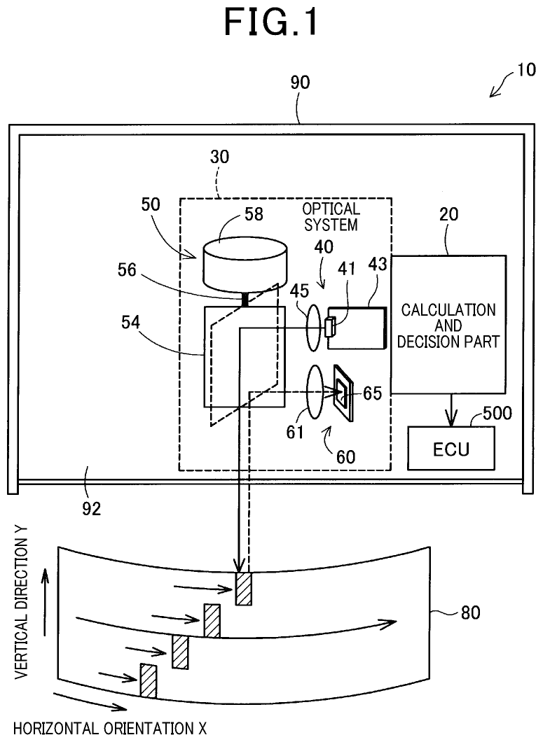

A rangefinder 10 shown in FIG. 1 includes an optical system 30 that emits pulsed light for distance measurement and receives the reflected light from an external object, a calculation and decision part 20 that processes a signal obtained from the optical system 30, and an ECU 500. The external object is also referred to as a “reflective object”. The optical system 30 includes a light emitting part 40 that emits a laser beam, a scanning part 50 that scans a predetermined field-of-view area 80 with the laser beam, and a light receiving part 60 that receives incident light including the reflected light from the external object and ambient light. The rangefinder 10 is housed in a casing 90 having a window 92 on the front. The window 92 transmits most of the pulsed light emitted from the light emitting part 40 and reflects part of it.

The rangefinder 10 is, for example, a vehicle-mounted LiDAR (Laser Imaging Detection and Ranging) mounted on a vehicle such as an automobile. When the vehicle is traveling on a horizontal road surface, the lateral direction of the field-of-view area 80 coincides with a horizontal direction X, and the vertical direction coincides with a vertical direction Y.

The light emitting part 40 includes a semiconductor laser element (hereinafter also simply referred to as a laser element) 41 that emits a laser beam including pulsed light, a circuit board 43 including a drive circuit of the laser element 41, a collimating lens 45 for converting the laser beam emitted from the laser element 41 into parallel light. The laser element 41 is a laser diode capable of causing so-called short-pulse laser light to oscillate. In the present embodiment, the laser element 41 forms a rectangular laser emitting region by arranging a plurality of laser diodes along the vertical direction. The intensity of the laser beam output by the laser element 41 can be adjusted according to the voltage supplied to the laser element 41.

A so-called one-dimensional scanner forms the scanning part 50. The scanning part 50 includes a mirror 54, a rotary solenoid 58, and a rotating part 56. The mirror 54 reflects the laser beam collimated by the collimating lens 45. The rotary solenoid 58 receives control signals from the calculation and decision part 20 and repeats forward rotation and reverse rotation within a predetermined angular range. The rotating part 56 is driven by the rotary solenoid 58, and repeats forward rotation and reverse rotation about a rotation axis whose axial direction is the vertical direction so as to cause the mirror 54 to scan in one direction along the horizontal direction. The laser beam emitted from the laser element 41 via the collimating lens 45 is reflected by the mirror 54 and caused to scan along the horizontal direction by the rotation of the mirror 54. The field-of-view area 80 shown in FIG. 1 corresponds to the whole scan area of this laser beam. Since a received light intensity is obtained at each pixel position within the field-of-view area 80, the distribution of received light intensities within the field-of-view area 80 forms a kind of image. Therefore, the field-of-view area 80 can also be referred to as an “image area”. In the present embodiment, pulsed light is emitted four times to each position in the scan area, in other words, each pixel position in the field-of-view area 80. After pulsed light is emitted four times, the laser beam is moved so that the position irradiated with the laser beam is moved to the adjacent pixel position in the field-of-view area 80. Then, that position is irradiated with the pulsed light four times. The scanning part 50 may be omitted, and the light emitting part 40 may emit pulsed light to the entire field-of-view area 80, and the light receiving part 60 may receive the reflected light from the entire field-of-view area 80.

A laser beam output from the light emitting part 40 is diffusely reflected off the surface of an external object (reflective object) such as a person or a car, and part of the reflected light returns to the mirror 54 of the scanning part 50. This reflected light is reflected by the mirror 54 and enters a light receiving lens 61 of the light receiving part 60 together with ambient light. The light receiving lens 61 concentrates the light and sends it to a light receiving array 65. The laser beam output from the rangefinder 10 is diffusely reflected not only by an external object but also by objects inside the rangefinder 10, for example, a window 92, and part of the reflected light is incident on the light receiving array 65.

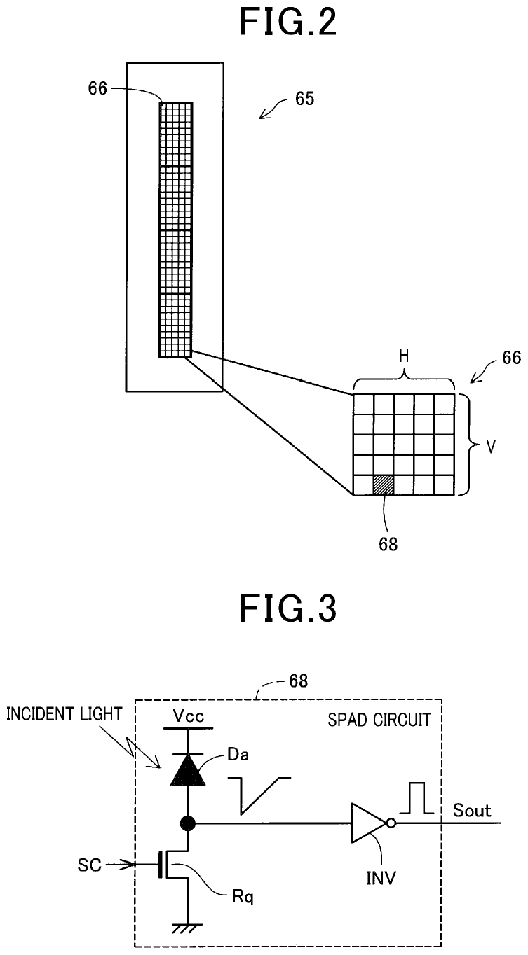

As shown in FIG. 2, the light receiving array 65 includes a plurality of pixels 66 arranged in two dimensions. One pixel 66 includes a plurality of single photon avalanche diode (SPAD) circuits 68 arranged in an array of H circuits in the horizontal direction and V circuits in the vertical direction. H and V are each an integer greater than or equal to 1. In the present embodiment, H=V=5, and an array of five SPAD circuits 68 in the horizontal direction and five SPAD circuits 68 in the vertical direction forms one pixel 66. However, a pixel 66 can include any number of SPAD circuits 68, and it is also possible that one SPAD circuit 68 forms a pixel 66. The light receiving result of one pixel 66 is the received light intensity at one pixel position in the field-of-view area 80.

As shown in FIG. 3, each SPAD circuit 68 connects an avalanche diode Da and a quenching resistor Rq in series between a power supply Vcc and the ground line. The voltage at the connection point between them is input to an inverting element INV, which is one of the logic operation elements, to convert it into a digital signal having inverted voltage level. An output signal Sout of the inverting element INV is output to the outside as it is. In the present embodiment, the quenching resistor Rq is configured as a FET, and when a selection signal SC is active, its on-resistance acts as the quenching resistor Rq. When the selection signal SC becomes inactive, the quenching resistor Rq turns into a high impedance state, and even when light is incident on the avalanche diode Da, no quenching current flows, and as a result, the SPAD circuit 68 does not operate. Selection signals SC are collectively output to the 5×5 SPAD circuits 68 in the pixel 66, and are used to specify whether to read the signal from each pixel 66 or not. In the present embodiment, the avalanche diode Da is operated in the Geiger mode, but the avalanche diode Da may be used in the linear mode and the output thereof may be treated directly as an analog signal. PIN photodiodes may be used instead of avalanche diodes Da.

When no light is incident on the SPAD circuit 68, the avalanche diode Da stays in a non-conductive state. Therefore, the input side of the inverting element INV stays in a state where it is pulled up via the quenching resistor Rq, in other words, the input side is kept at the high level H. Accordingly, the output of the inverting element INV is kept at the low level L. When light is incident on the SPAD circuits 68 from the outside, the incident light (photons) causes the avalanche diodes Da to shift to the conducting state. As a result, a large current flows through the quenching resistor Rq, and the input side of the inverting element INV temporarily changes to the low level L, whereas the output of the inverting element INV is inverted to the high level H. Since a large current flows through the quenching resistor Rq, the voltage applied to the avalanche diode Da decreases. The power supply to the avalanche diode Da stops, and the avalanche diode Da returns to the non-conducting state. As a result, the output of the inverting element INV is also inverted and returns to the low level L. Consequently, when light (photons) is incident on a SPAD circuit 68, the inverting element INV outputs a high-level pulse signal for a very short time. Therefore, if the selection signal SC is set to the high level H at the timing when a SPAD circuit 68 receives light, the output signal of the inverting element INV, that is, the output signal Sout from the SPAD circuit 68 will be a digital signal reflecting the state of the avalanche diode Da. The output signal Sout corresponds to a pulse signal generated by receiving the incident light including reflected light, that is, the reflections of the emitted light from an external object in the scan area, a window 92, or the like, as well as ambient light.

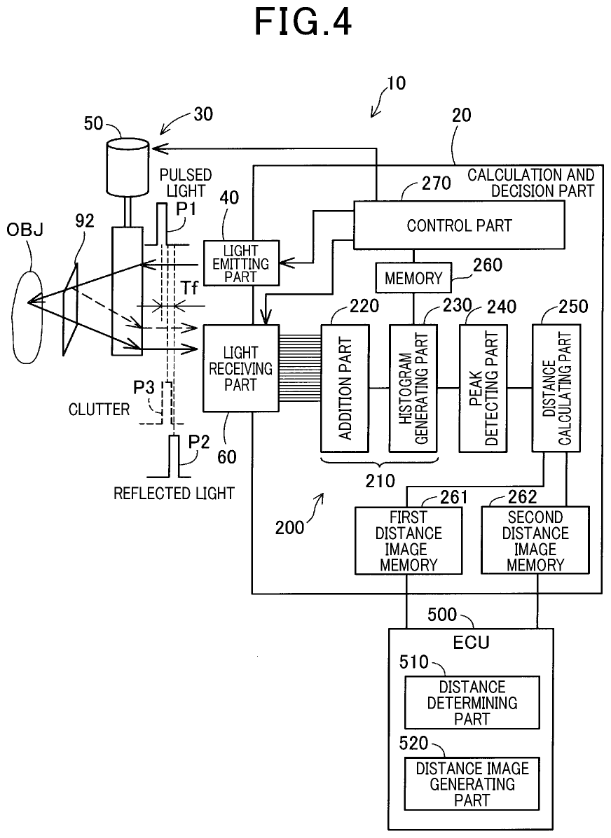

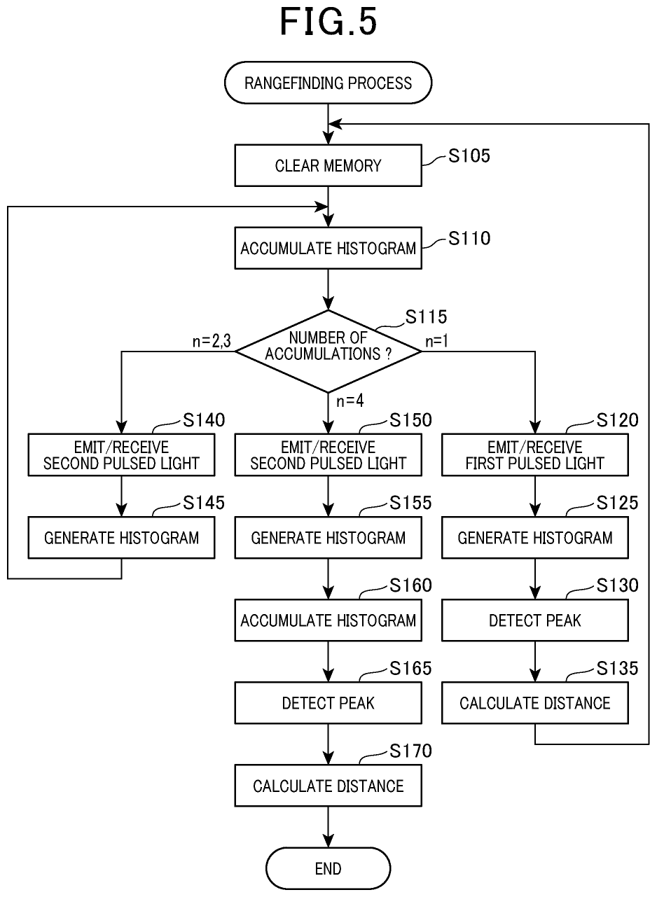

As shown in FIG. 4, the calculation and decision part 20 includes a calculating part 200, a memory 260, a first distance image memory 261 and a second distance image memory 262, and a control part 270. The calculating part 200 calculates the distance to the reflective objector that reflects the pulsed light and outputs the reflected light by using the time of flight of the reflected light received by the light receiving part 60. This distance calculation method can be summarized as follows. As shown in FIG. 4, pulsed light P1 emitted from the light emitting part 40 is reflected off a reflective object OBJ which is an external object. In other words, the reflective object OBJ outputs reflected light P2 of the pulsed light P1. Further, the pulsed light P1 is also reflected off the inner surface of the window 92, and reflected light P3 is output. As a result, the reflected light P2 and the reflected light P3 reach the light receiving part 60. The time from the emission of the pulsed light P1 to the reception of the reflected light P2 and reflected light P3 is determined as the time of flight Tf of the light. The calculating part 200 calculates the distance from the rangefinder 10 (the light emitting part 40 and the light receiving part 60) to the reflective object OBJ using this time of flight Tf.

The calculating part 200 includes a received light intensity determining part 210, a peak detecting part 240, and a distance calculating part 250.

The received light intensity determining part 210 determines the intensity of received light incident on the light receiving part 60 for each of a plurality of times of flight. The light receiving part 60 receives, in addition to the reflected light of the pulsed light emitted from the light emitting part 40, various kinds of ambient light such as sunlight, reflected light of sunlight from an external object, and the light of a street lamp. The timing at which these rays of ambient light are received varies, and they are detected as different times of flight. Therefore, the received light intensity is determined for each of the plurality of times of flight. The received light intensity determining part 210 includes an addition part 220 and a histogram generating part 230.

The addition part 220 adds the outputs of the SPAD circuits 68 included in the light receiving elements 66 constituting the light receiving part 65. When an incident light pulse enters one pixel 66, the SPAD circuits 68 included in the pixel 66 operate. The SPAD circuits 68 can detect even a single incident photon. However, the detection of the limited light output from the reflective object OBJ by the SPAD circuit 68 is inevitably probabilistic. Therefore, the addition part 220 is configured to add the output signals Sout from all the SPAD circuits 68, which may not individually detect the light which is incident only probabilistically, included in each pixel 66 in order to detect the reflected light from the reflective object OBJ with higher reliability in each pixel 66.

The histogram generating part 230 generates a histogram of the received light intensity by acquiring the addition results of the addition part 220 in time series, stores it in the memory 260, and outputs it to the peak detecting part 240. Further, as will be described later, the histogram generating part 230 generates a new histogram by accumulating the newly generated histogram on top of a histogram already stored in the memory 260. The histogram generated by the histogram generation part 230 can be considered as a graph showing the received light intensity for each of the plurality of times of flight. The received light intensity is the total number of SPAD circuits 68 that have received light in one pixel 66. The plurality of times of flight are set at regular time intervals. As described above, the light emitting part 40 emits pulsed light four times in succession. Once the histogram generating part 230 has generated a histogram representing the reception intensity within a certain period of time including the time of flight of the first pulse, the memory 260 is cleared by the control part 270. Then, after the histograms each representing the reception intensity within a certain period of time including the time of flight of the corresponding one of the pulsed beams emitted for the second to fourth times are generated and accumulated, the memory 260 is cleared by the control part 270. The accumulation and storage of histograms, and clearing of the memory 260 will be described in detail later.

The peak detecting part 240 detects the time of flight of the peak of the histogram generated by the histogram generating part 230. Specifically, the peak detecting part 240 analyzes the received light intensities of the histogram input from the histogram generating part 230, detects the peak received light intensity, and determines the time of flight of the detected peak. The time of flight of the detected peak corresponds to the time of flight Tf of the light reflected by the reflective object OBJ, the window 92, and the like.

The distance calculating part 250 calculates the distance to the reflective object OBJ from the time of flight Tf of the light identified by the peak detecting part 240.

The memory 260 is used in the generation and accumulation of the received light intensity histograms described later. The first distance image memory 261 stores the distance to the reflective object OBJ for each pixel calculated in step S135 of a rangefinding process described later. The second distance image memory 262 stores the distance to the reflective object OBJ for each pixel calculated in step S170 of the rangefinding process described later.

The control part 270 controls the entire rangefinder 10. For example, the control part 270 controls the intensity of the pulsed light by controlling the voltage supplied to the laser element 41 of the light emitting part 40. Further, for example, the control part 270 clears the memory 260. The ECU 500 includes a microprocessor unit (MPU) and a memory. By executing control programs stored in the memory in advance, the MPU functions as a distance determining part 510 and a distance image generating part 520. The distance image generating part 520 uses the distances calculated by the distance calculating part 250 to determine the distance to the reflective object OBJ for each pixel (hereinafter, referred to as a “measurement target distance”). The distance image generating part 520 uses the measurement target distance determined by the distance determining part 510 to generate an image indicating the measurement target distance for each pixel (hereinafter, referred to as “distance image”). The position of each pixel refers to the position (direction) of the reflective object as seen from the rangefinder 10. Therefore, it can be said that the distance image is an image showing the position of the reflective object OBJ and the distance to the reflective object OBJ. The distance image generating part 520 generates, in a distance image generating process described later, one distance image (integrated distance image) by combining two distance images together. For example, in a configuration in which the rangefinder 10 is mounted on an autonomous vehicle, the integrated distance image generated in this way is used in driving control such as detecting obstacles around the vehicle and avoiding the detected obstacles.

As described above, as with the reflected light from the reflective object OBJ, the reflected light (clutter) from the window 92 is also incident on the light receiving part 60. Therefore, in general, the clutter may cause an error in the measurement of the distance to the reflective object OBJ near the rangefinder 10. However, by executing the rangefinding process and distance image generating process described later, the rangefinder 10 can reduce the influence of the clutter, accurately calculate the distance (measurement target distance) to the reflective object OBJ near the rangefinder 10, and generate a highly accurate integrated distance image.

### A2. Rangefinding Process:

The rangefinding process shown in FIG. 5 means a process for calculating the distance (measurement target distance) from the rangefinder 10 to the reflective object OBJ. When the rangefinder 10 is turned on, the rangefinding process is executed. This rangefinding process is executed for each pixel position.

The control part 270 clears the memory 260 (step S105). The histogram generating part 230 accumulates the histogram (step S110). When step S110 is executed for the first time after clearing the memory 260, no histogram is generated because the light emitting part 40 has not yet emitted the pulsed light and the light receiving part 60 has not received the reflected light. Therefore, in this case, no histogram is accumulated in the memory 260.

The control part 270 determines the number of accumulations n (step S115). In the present embodiment, the number of accumulations n refers to the number accumulations it will be (the number of times accumulation will have been performed) when the histogram that would be obtained by the following emission of pulsed light and reception of the reflected light is accumulated. In the case where step S115 is performed for the first time after step S105 has been performed, the number of accumulations n is 1. As described above, pulsed light is emitted four times in succession for each pixel position at predetermined time intervals. As will be described later, the histogram accumulation (step S110) is executed each time.

When the number of accumulations is determined to be the first time, the control part 270 controls the light emitting part 40 to emit low-intensity pulsed light (hereinafter referred to as “first pulsed light”), and causes the light receiving part 60 to receive light during a predetermined time including the estimated time of flight of the pulsed light (step S120). The intensity of the first pulsed light is set based on experiments or the like in advance so that the reflected light (clutter) generated by the first pulsed light reflecting off the window 92 has a received light intensity at which a predetermined number or more of the SPAD circuits 68 constituting each pixel 66 do not operate, but the reflected light from the reflective object of the external object causes more than the predetermined number of the SPAD circuits 68 constituting each pixel 66 to operate, and has a received light intensity equal to or higher than a predetermined received light intensity. Since such first pulsed light is set to have such a small intensity that the light receiving part 60 cannot detect the clutter, only the reflected light from a reflective object whose distance from the rangefinder 10 is equal to or smaller than a threshold distance is detected. On the other hand, the reflected light from a reflective object whose distance from the rangefinder 10 is greater than the threshold distance cannot be detected as received light.

When the reflected light is received by the light receiving part 60, the addition part 220 adds up the outputs of the SPAD circuits 68 included in each pixel 66. The histogram generating part 230 generates a histogram of each pixel, stores the generated histogram in the memory 260, and at the same time outputs it to the peak detecting part 240 (step S125). In the present embodiment, storing a histogram corresponding to the pulsed light of the first emission in the memory 260 is referred to as accumulation of a first histogram. In the present embodiment, this first histogram (the received light intensity of each time of flight) corresponds to first received light intensities of the present disclosure.

The peak detecting part 240 detects the peak of the input histogram and determines its time of flight (step S130). The distance calculating part 250 calculates the distance based on the time of flight of the peak determined in step S130 (step S135). The calculated distance is associated with each pixel position and stored in the first distance image memory 261. After completing step S135, the process returns to step S105. Therefore, in this case, the data of the first histogram stored in the memory 260 is deleted by step S105.

When step S110 is performed for the second time after starting the rangefinding process, the histogram data is also not accumulated because the data of the first histogram is deleted. In step S115 performed after that, the number of accumulations is determined to be 2. In this case, the control part 270 controls the light emitting part 40 to emit high-intensity pulsed light (hereinafter referred to as “second pulsed light”), and also causes the light receiving part 60 to receive light during a predetermined time including the expected time of flight of the pulsed light (step S140). The intensity of the second pulsed light is determined and set based on experiments or the like in advance so that the reflected light from a reflective object (external object) within a predetermined distance of the rangefinder 10 causes a predetermined number or more of the SPAD circuits 68 constituting each pixel 66 to operate, and has a received light intensity equal to or higher than a predetermined received light intensity. The “predetermined distance” is larger than the “threshold distance” described above with regard to the first pulsed light. This second pulsed light is reflected by both the external object within the predetermined distance and the window 92, and the reflected rays are detected as received light by the light receiving part 60.

After completing step S140, the addition part 220 adds up the outputs of the SPAD circuits 68 included in each pixel 66, and the histogram generating part 230 generates a histogram for each pixel (step S145). After completing step S145, the process returns to step S110. Therefore, in this case, in step S110, the histogram generated in step S145 is accumulated and stored in the memory 260. In step S115 performed after that, the number of accumulations is determined to be 3. In this case, the process returns to step S110 after performing steps S140 and S145. In this case, in step S110, the histogram corresponding to the pulsed light of the third emission is accumulated and stored in the memory 260. That is, the histogram corresponding to the pulsed light of the third emission is accumulated on top of the histogram corresponding to the pulsed light of the second emission.

In step S115 performed thereafter, the number of accumulations is determined to be 4. In this case, the control part 270 causes the light emitting part 40 to emit the second pulsed light, and causes the light receiving part 60 to receive light during a predetermined time including the expected time of flight of that pulsed light (step S150). The addition part 220 adds up the outputs of the SPAD circuits 68 included in each pixel 66, and the histogram generating part 230 generates a histogram for each pixel (step S155). The histogram generating part 230 accumulates and stores the histogram corresponding to the pulsed light of the fourth emission in the memory 260 (step S160). In this case, the histogram corresponding to the pulsed light of the fourth emission is accumulated on top of the histogram corresponding to the pulsed light of the second emission and the pulsed light of the third emission. The histogram (the received light intensity for each time of flight) obtained by accumulating the second to fourth histograms corresponds to a second received light intensity of the present disclosure.

The peak detecting part 240 detects the peak of the histogram stored in the memory 260 and determines the time of flight (step S165). The distance calculating part 250 calculates the distance based on the time of flight of the peak determined in step S165 (step S170). The calculated distance is associated with the corresponding pixel position and stored in the second distance image memory 262. After completing step S170, the rangefinding process for that pixel position ends. After that, the laser beam is moved to the adjacent pixel position to carry out the rangefinding process at another pixel position.

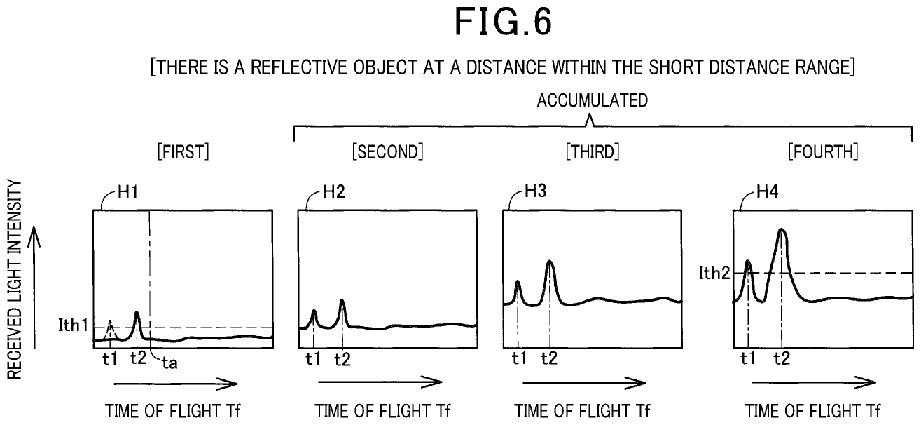

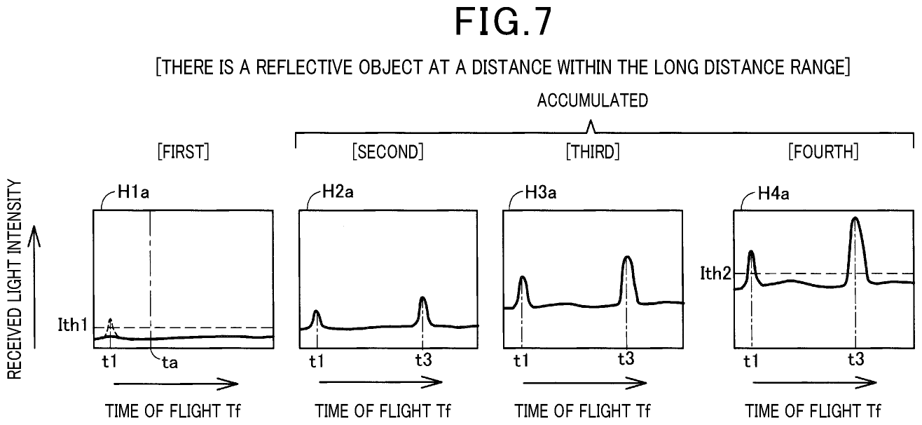

Examples of the histograms stored in the memory 260 as a result of executing the rangefinding process described above will be described with reference to FIGS. 6 and 7. FIG. 6 shows example histograms in the case where there is a reflective object within the threshold distance (hereinafter referred to as a “short distance range”). FIG. 7 shows example histograms in the case where there is a reflective object at a distance within a range of distances larger than the threshold distance (hereinafter referred to as a “long-distance range”).

In a case where there is a reflective object different from the window 92, that is, an external object at a distance within the short distance range at a certain pixel position, when the pulsed light is emitted for the first time and the reflected light is received, as shown in FIG. 6, a first histogram H1 has a peak at a time of flight t2 shorter than a time of flight ta. The time of flight ta is the time of flight corresponding to the above-mentioned threshold distance. This peak represents the reflected light output from the reflective object. On the other hand, the reflected light output from the window 92 may appear as a peak at a time of flight t1 shorter than the time of flight t2. However, as described above, since the intensity of the first pulsed light is determined so that its clutter cannot be detected by the light receiving part 60, a peak corresponding to the clutter does not appear. Since there is no other peak near the time of flight t2, the time of flight t2 can be detected accurately. Specifically, a range of times of flight in which the received light intensity is higher than a first threshold intensity Ith1 is determined, and the peak time of flight t2 is detected as the median value thereof.

In the present embodiment, after the time of flight of the peak corresponding to the pulsed light of the first emission is calculated, the memory 260 is cleared, and histograms will be accumulated and stored in the memory 260 thereafter. Since the second pulsed light is used when pulsed light is emitted for the second and subsequent times, as shown in FIG. 6, the second histogram H2 shows a peak at the time of flight t1 corresponding to the time of flight of the clutter in addition to the peak at the time of flight t2. This time of flight t1 is close to the time of flight t2. Since the histograms H3 and H4 generated corresponding to the third and fourth emissions and receptions of the second pulsed light, respectively, are accumulated, the received light intensity of each time of flight increases as the emission of pulsed light is repeated. By accumulating the histograms in this way, the ratio of the reflected light to the ambient light, that is, the S/N ratio is increased, which makes it possible to accurately detect the peak of the reflected light from the reflective object. In the example of FIG. 6, the peak at the time of flight t1 and the peak at the time of flight t2 can be distinguished, and two peaks and two times of flight t1 and t2 are detected in this case. Note that, in the fourth histogram H4, a range of intensities larger than the second threshold intensity Ith2 is found, and the above-mentioned two peaks and times of flight t1 and t2 are found therefrom.

As shown in FIG. 7, in a case where there is an external object at a distance within the long-distance range at a certain pixel position, when pulsed light is emitted for the first time and the reflected wave is received, as with the example of FIG. 6, the first histogram H1a does not have a peak at the time of flight t1. Further, since the reflective object is at a distance within the long-distance range, the reflected light of the first pulsed light is not detected by the light receiving part 60, and therefore, the first histogram H1 a does not have a peak corresponding to the reflective object either. On the other hand, in the second histogram H2a, the third histogram H3a, and the fourth histogram H4a, peaks appear at the time of flight t1 and the time of flight t3. The peak at the time of flight t3 corresponds to the reflected light output from the reflective object. Then, as a result of the second to fourth histograms H2a to H4a accumulating, the received light intensities of the two peaks at the times of flight t1 and t3 exceed the second threshold intensity Ith2, and these two peaks and the two times of flight t1 and t3 are detected.

### A3. Distance Image Generating Process:

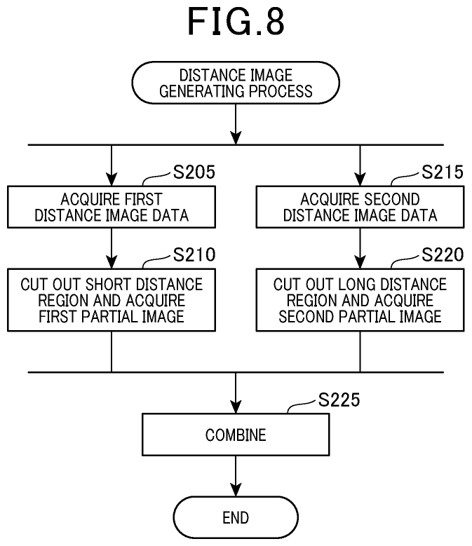

The distance image generating process shown in FIG. 8 refers to a process for generating a distance image. When the above-mentioned rangefinding process has been executed for all the pixel positions in the field-of-view area 80, the distance determining part 510 and the distance image generating part 520 execute the distance image generating process.

The distance determining part 510 acquires first distance image data from the first distance image memory 261 (step S205). A first distance image is an image including, for each pixel, the distance calculated based on the time of flight of the peak obtained from the histogram corresponding to the emission of the first pulsed light. That is, it refers to the distance data of pixels that is stored in the first distance image memory 261. The distance determining part 510 uses the first distance image data obtained in step S205 to cut out a short distance region from the first distance image and acquire a first partial image (step S210). The short distance region refers to a region within a radius of the above-mentioned threshold distance of the rangefinder 10. This step S210 corresponds to a process of determining the distance indicated by the first distance image data as the measurement target distance in the short distance region. The distance image generating part 520 executes steps S215 and S220 described later in parallel with steps S205 and S210 described above.

The distance determining part 510 acquires second distance image data from the second distance image memory 262 (step S215). A second distance image is an image including, for each pixel, the distance calculated based on the time of flight of the peak obtained from the histogram obtained by accumulating the histograms corresponding to the emissions of the second pulsed light. That is, it refers to the distance data of pixels that is stored in the second distance image memory 262. The distance determining part 510 uses the second distance image data obtained in step S215 to cut out a long-distance region from the second distance image and acquire a second partial image (step S220). The long-distance region refers to a region outside the region within a radius of the above-mentioned threshold distance of the rangefinder 10. This step S220 corresponds to a process of determining the distance indicated by the second distance image data as the measurement target distance in the long-distance region.

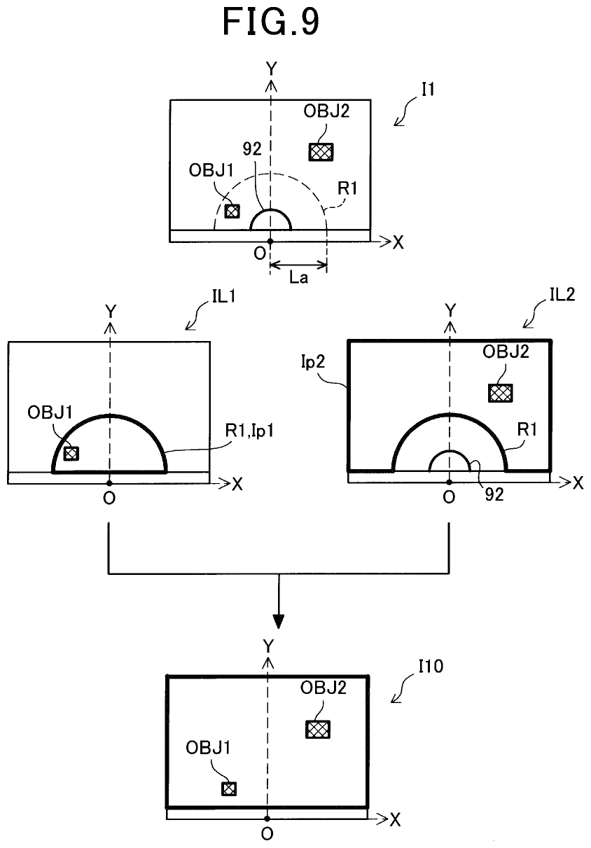

After completing steps S210 and S220 described above, the distance image generating part 520 combines the first partial image acquired in step S210 with the second partial image acquired in step S220 to generate an integrated distance image (step S225), and then the distance image generating process ends. The first and second distance images and the integrated distance image generated in the above-described distance image generating process will be described in detail with reference to FIG. 9.

In FIG. 9, the top row shows an image I1 showing an example of the positional relationship of the two reflective objects OBJ1 and OBJ2 and the window 92. In FIG. 9, the middle row shows the first distance image IL1 and the second distance image IL2. In FIG. 9, the bottom row shows the integrated distance image I10. Each image in FIG. 9 shows a plan view as viewed in the vertical direction. In the first distance image IL1, the first partial image Ip1 is outlined by a thick solid line. Similarly, in the second distance image IL2, the second partial image Ip2 is outlined by a thick solid line. The X-axis and the Y-axis of FIG. 9 have their origin O at the center of gravity of the rangefinder 10 and are parallel to the horizontal direction.

As shown in the image I1 of FIG. 9, in the region R1 within a radius of the threshold distance La of the rangefinder 10, there is the reflective object OBJ1 as an external object in addition to the window 92. Further, the reflective object OBJ2 is located at a distance longer than the threshold distance La from the rangefinder 10. In such a situation, as shown in the left drawing in the middle row of FIG. 9, the first partial image Ip1 cut out from the first distance image IL1 only contains the distance data for the reflective object OBJ1 in the region R1, and does not contain distance data for other objects, such as the window 92 (clutter). Further, as shown in the right drawing in the middle row of FIG. 9, the second partial image Ip2 cut out from the second distance image IL2 only contains the distance data for the reflective object OBJ2 in the region outside the region R1, and does not contain distance data for other objects, such as the reflective object OBJ1 and the window 92. By integrating these two partial images Ip1 and Ip2, as shown in the bottom row of FIG. 9, the integrated distance image I10 contains only the distance data for the reflective objects OBJ1 and OBJ2 and does not contain the window 92 (clutter). Therefore, for example, it is possible to prevent the vehicle taking a sudden avoidance action due to the presence of the window 92 (clutter).

According to the rangefinder 10 of the first embodiment described above, at each pixel position, one of a total of four emissions of pulsed light is emitted as the first pulsed light having a low intensity. This makes it possible to exclude the distance to the window 92 determined from the reflected light (clutter) from the window 92 from the acquired first distance (first distance image). Since the influence of the clutter is suppressed, the peak of a reflective object at a short distance from the rangefinder 10 can be accurately detected, and thus the distance to the reflective object (measurement target distance) can be accurately measured. In addition, three of a total of four emissions of pulsed light are emitted as the second pulsed light with a higher intensity, and the peak is detected using a histogram obtained by accumulating the acquired histograms. This makes it possible to identify the peak after improving the S/N ratio. Therefore, the distance (second distance) of each of the pixels in the second distance image can be accurately determined.

Further, since the integrated distance image is generated by combining the first partial image, which is the part of the first distance image related to a reflective object within the threshold distance of the rangefinder, and the second partial image, which is the part of the second distance image related to a reflective object at a distance longer than the threshold distance from the rangefinder, a distance image (integrated distance image) can be generated that accurately indicates the respective positions and distances of the reflective object within the threshold distance of the rangefinder and the reflective object at a distance larger than the threshold distance.

Further, the peak detecting part 240 determines a range of times of flight in which the received light intensity is higher than the corresponding one of the intensity thresholds Ith1 and Ith2 in a histogram, and detects the time of flight of the received light intensity peak within the determined range. This makes it possible to accurately detect the time of flight of the peak.

### B. Second Embodiment

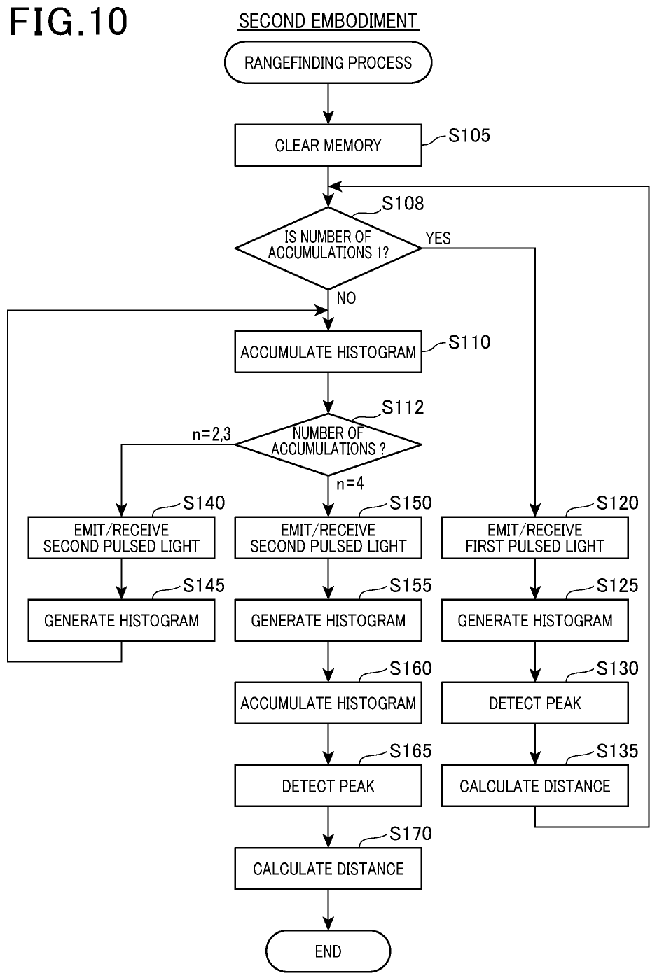

Since the device configuration of the rangefinder 10 of the second embodiment is the same as that of the first embodiment, the same components will be assigned with the same reference signs, and they will not be described in detail. The rangefinding process of the second embodiment shown in FIG. 10 is different from the rangefinding process of the first embodiment in that step S108 is additionally executed and step S112 is executed instead of step S115. Since the other procedures of the rangefinding process and the distance image generating process of the second embodiment are the same as those of the first embodiment, the same procedures are assigned with the same reference sings, and they will not be described in detail.

As shown in FIG. 10, after completing step S105, the control part 270 determines whether the number of accumulations indicates the first time (step S108). When it is determined that it is the first time (step S108: YES), the above-described steps S120 to S135 are executed. Therefore, when the rangefinding process is started at a certain pixel position and step S108 is executed for the first time, the number of accumulations is determined to be 1, and steps S120 to S135 are executed. After completing step S135, the process returns to step S108. Therefore, in the present embodiment, step S105 is not executed in this case.

When it is determined that it is not the first time (step S108: NO), the above-described step S110 is executed, and the histogram is accumulated and stored in the memory 260. After completing step S110, the control part 270 determines the number of accumulations n (step S112). This step S112 is different from step S115 of the first embodiment in that the total number of times is determined (identified) to be one of 2, 3 and 4, and is not determined to be 1.

When the number of accumulations is the second or third time, the above-described steps S140 to S145 are performed. After completing step S145, the process returns to step S110 as in the first embodiment. After the first histogram is stored in the memory 260, the memory 260 is not cleared in the second embodiment. Therefore, the histogram corresponding to the second emission of light is stored in the memory 260 by being accumulated on top of the first histogram already stored in the memory 260.

When the number of accumulations is the fourth time, the above-described steps S150 to S170 are executed. The histogram obtained after completing step S160 is a histogram obtained by accumulating all the histograms of the first to fourth times. After completing step S170, the rangefinding process at that pixel position ends.

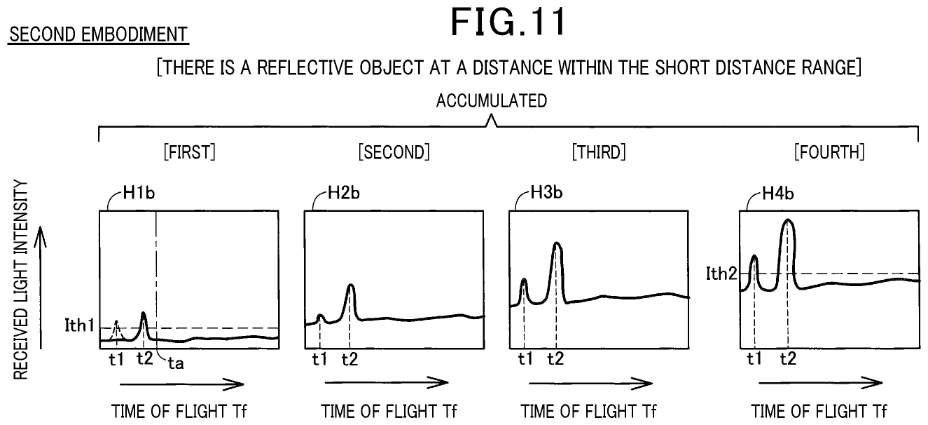

As shown in FIG. 11, when there is a reflective object is present at a distance within the short distance range, as in the first embodiment, the first histogram H1b has a peak at only the time of flight t2 representing the reflective object, and does not have a peak at the time of flight t1 caused by the clutter. After that, in a histogram H2b obtained by accumulating the second histogram, a peak appears at the time of flight t1. The received light intensity is higher in a histogram H3b obtained by accumulating the third histogram, and even higher in a histogram H4b obtained by accumulating the fourth histogram. In the final histogram H4b, two peaks are detected in the ranges in which the intensity is equal to or higher than the threshold intensity Ith2.

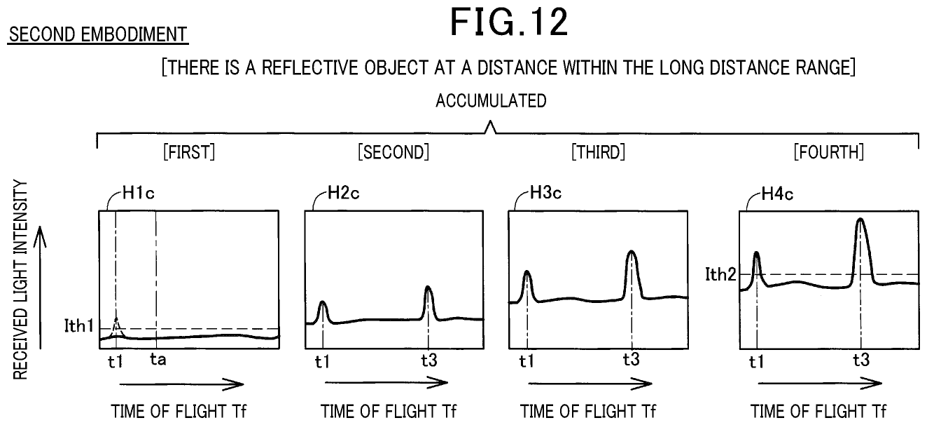

As shown in FIG. 12, when there is a reflective object at a distance within the long-distance range, no peak appears in a first histogram Hic as in the first embodiment. After that, in a histogram H2c obtained by accumulating the second histogram, peaks appear at the times of flight t1 and t3. The received light intensity is higher in a histogram H3c obtained by accumulating the third histogram, and even higher in a histogram H4c obtained by accumulating the fourth histogram. In the final histogram H4c, two peaks are detected in the ranges in which the intensity is equal to or higher than the threshold intensity Ith2.

The rangefinder 10 of the second embodiment described above provides effects similar to those of the rangefinder 10 of the first embodiment. In addition, since the peak is detected from a histogram obtained by accumulating all of the first to fourth histograms, the S/N ratio can be further improved, and the peak detection accuracy and the accuracy of detecting the positions of and distances to the reflective objects can be further improved.

### C. Third Embodiment

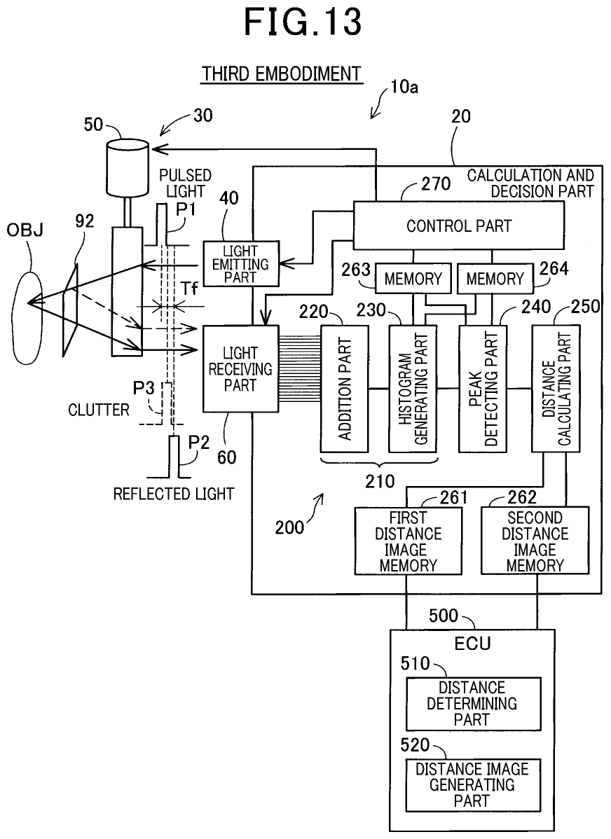

The rangefinder 10a of the third embodiment shown in FIG. 13 has a configuration similar to that of the rangefinder 10 of the first embodiment except that the calculation and decision part 20 of the rangefinder 10a includes two memories 263 and 264 instead of the memory 260. Therefore, the same components are assigned with the same reference signs and will not be described in detail.

The memories 263 and 264 are both accessible from the control part 270, the histogram generating part 230, and the peak detecting part 240. In the memory 263, only the received light intensities within a predetermined time and the times of flight at which those received light intensities were recorded are overwritten and stored. The histograms generated by the histogram generating part 230 are stored in the memory 264 without being accumulated each time. The memory 263 corresponds to a first storage part. The memory 264 corresponds to a second storage part.

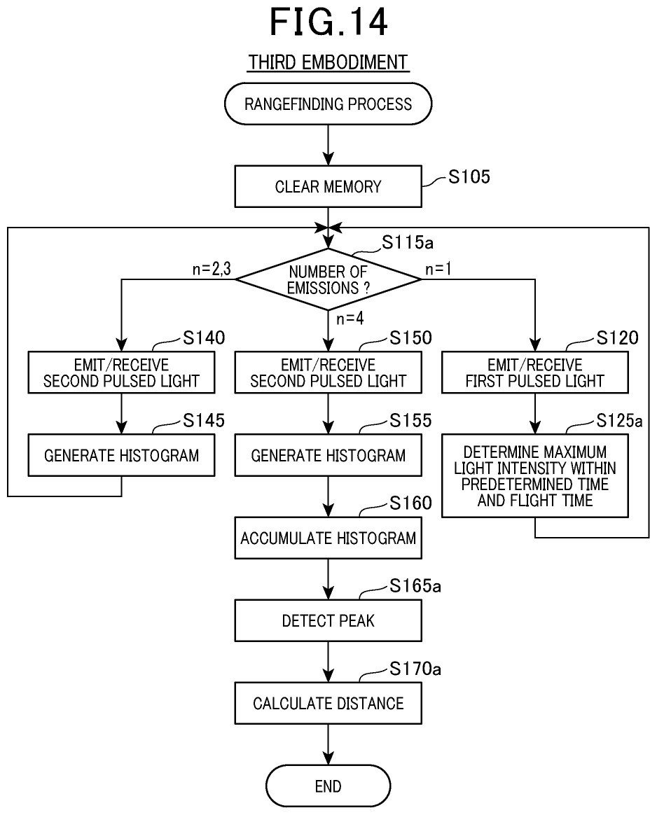

The rangefinding process of the third embodiment shown in FIG. 14 differs from the rangefinding process of the first embodiment shown in FIG. 5 in that step S110 is omitted, step S115a is performed instead of step S115, step S125a is performed instead of step S125, steps S130 and S135 are omitted, step S165a is performed instead of step S165, and step S170a is executed instead of step S170. Since the other procedures of the rangefinding process of the third embodiment are the same as those of the first embodiment, the same procedures are assigned with the same reference signs and will not be described in detail.

After completing step S105, the control part 270 determines the number of times pulsed light has been emitted at that pixel position (step S115a). When the number of emissions is determined to be the first time, the control part 270 executes the above-described step S120 to emit the first pulsed light and receive the reflected light. After completing step S120, the histogram generating part 230 stores the received light intensity that has been added up in the memory 263 for each of the times of flight within the predetermined time one after another. At this time, when the received light intensity (the number of outputs of the SPAD circuit 68 added up) is larger, that received light intensity and the corresponding time of flight are stored in the memory 263 by overwriting the information already stored therein with them. That is, when the received light intensity at a certain time of flight is larger than the received light intensity already stored in the memory 263, the time of flight and the corresponding received light intensity are stored in the memory 263 by overwriting the information already stored therein. After completing step S125a, the process returns to step S115a.

When the number of emissions is determined to be the second or third time in step S115a, the above-described steps S140 and S145 are performed as in the first embodiment. In step S145, the histogram generated in that cycle is stored in the memory 264 as it is. After completing step S145, the process returns to step S115a. At this time, unlike the first embodiment, the histogram is not accumulated.

When the number of emissions is determined to be the fourth time in step S115a, steps S150 to S160 are performed as in the first embodiment. In step S160 of the third embodiment, the second to fourth histograms stored separately in the memory 264 are accumulated.

The peak detecting part 240 detects the peaks of the accumulated histogram obtained in step S160 and determines their times of flight, and reads out the times of flight stored in the memory 263 and determines that those times of flight are the times of flight of the peaks (step S165a).

The distance calculating part 250 calculates the distances to the reflective objects based on the times of flight of the two peaks found in step S165a (step S170a). In this step S170a, the position and distance of the reflective object identified by emitting the first pulsed light are determined, and also the position and distance of the reflective object identified by emitting the second pulsed light a total of three times and receiving the reflected light are determined. Then, they are stored as distance images in the first distance image memory 261 and the second distance image memory 262, respectively.

The rangefinder 10a of the third embodiment described above provides effects similar to those of the rangefinder 10 of the first embodiment. In addition, when the first pulsed light is emitted and the received light intensities at a plurality of times of flight are determined sequentially, the time of flight corresponding to a higher received light intensity is updated and stored in the memory 263, and the time of flight stored in the memory 263 is detected as the time of flight of the peak. This makes it possible to prevent the storage area from detecting the time of flight of each peak, that is, the storage area of the memory 263 from becoming excessively large.

### D. Fourth Embodiment

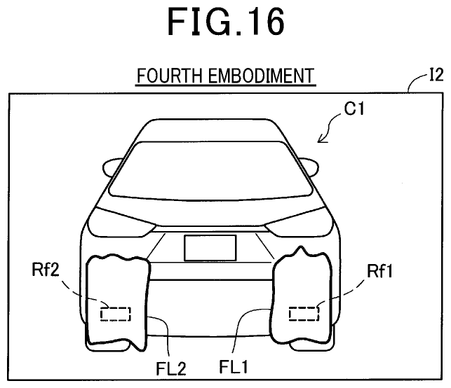

Since the device configuration of the rangefinder 10 of the fourth embodiment is similar to that of the first embodiment, the same components are assigned with the same reference signs and will not be described in detail. The rangefinder 10 of the fourth embodiment is different from the rangefinder 10 of the first embodiment in the details of the procedures of the distance image generating process. Since the rangefinding process of the fourth embodiment is the same as the rangefinding process of the first embodiment, the same procedures are assigned with the same reference signs, and those procedures will not be described in detail. However, in the present embodiment, in step S135, in addition to the distance calculated, the received light intensity of the peak is also stored in the first distance image memory 261. Further, in step S170, in addition to the calculated distance, the received light intensity of the peak is also stored in the second distance image memory 262. The distance image (integrated distance image) obtained by the distance image generating process of the fourth embodiment is an image that is less affected by the flare. This flare will be described with reference to FIG. 16.

An image 12 of FIG. 16 shows, with thick solid lines, flares FL1 and FL2 generated at the lower left and right of the rear part of the vehicle Cl, respectively. These flares FL1 and FL2 are centered at reflectors Rf1 and Rf2 having a very high reflectance. Since the reflectance of the reflectors Rf1 and Rf2 are very high, when the pulsed light emitted from the rangefinder 10 or sunlight hits the reflectors Rf1 and Rf2, reflected light having a very high intensity is output. When the light receiving part 60 receives such reflected light having a very high intensity, in the light receiving part 60, light also enters the pixels 66 near the pixels 66 that receive the reflected rays from the reflectors Rf1 and Rf2, and are counted as a reception of light. As a result, the distance to a portion that would have been determined correctly if not for the flare, for example, the distances to portions near the rear tires of the vehicle Cl may be erroneously calculated. However, the rangefinder 10 of the fourth embodiment can suppress the influence of a flare and accurately calculate the distance to the reflective object OBJ by executing the distance image generating process described below.

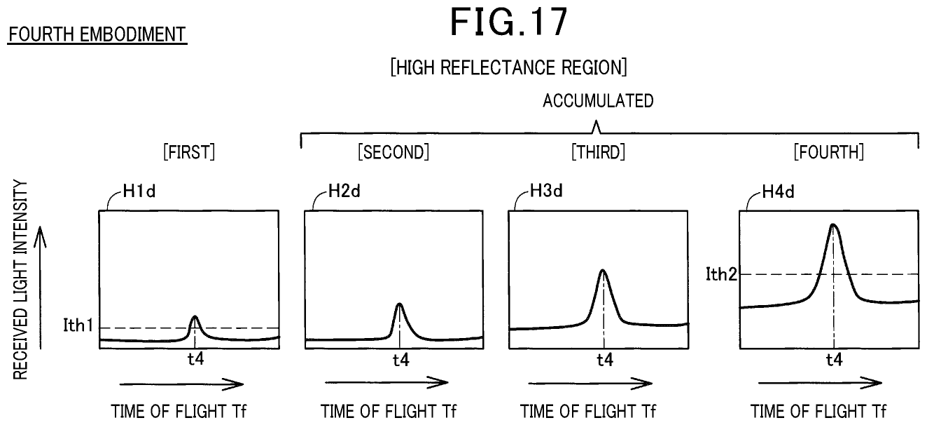

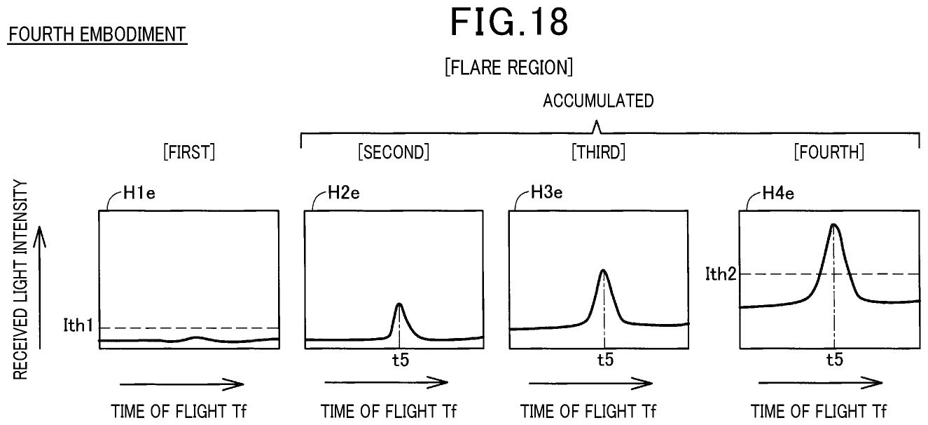

In the fourth embodiment, the intensity of the first pulsed light used in the rangefinding process is set in advance based on an experiment or the like so that, when the first pulsed light is reflected off an external object having a reflectance of a predetermined value or higher and located within a predetermined distance of the rangefinder 10, and the reflected light is received by the light receiving part 60, no flare occurs. When the vehicle Cl as shown in FIG. 16 is in the field-of-view area 80, histograms such as those shown in FIGS. 17 and 18 are generated by the rangefinding process.

FIG. 17 shows histograms that are obtained at a pixel position including a region of an object having a very high reflectance (hereinafter, referred to as a “high reflectance region”) such as the reflector Rf1 or Rf2. When the first pulsed light is emitted, reflected light is generated in the high reflectance region, and no reflected light is generated in the other regions. Therefore, a first histogram H1d has a peak at a time of flight t4 corresponding to the high reflectance region (a region where the reflector Rf1 or Rf2 is present). Since this peak exceeds the first threshold intensity Ith1, it will be detected. After that, as in the first embodiment, the peak at the time of flight t4 also appears in a second histogram H2d. The intensity at every time of flight increases in a histogram H3d obtained by accumulating the third histogram, and further increases in a histogram H4d obtained by accumulating the fourth histogram. In the final histogram H4d, the peak at the time of flight t4 is detected as a peak in the range of the second threshold intensity Ith2 or higher.

FIG. 18 shows histograms that are obtained at a pixel position including a region that is in the vicinity of the reflector Rf1 or Rf2 and in which a flare occurs (hereinafter, referred to as a “flare region”), in other words, a region that would be hidden by a flare should a flare occur. In the case where the first pulsed light is emitted, the reflected light of the first pulsed light is not detected by the light receiving part 60 because the reflectance of the flare region is not high in the first place. Therefore, no peak is detected in a first histogram H1e. On the other hand, when the second pulsed light is emitted, the received light intensity becomes very high because a flare occurs. Therefore, a second histogram H2e has a peak at a time of flight t5, which is a peak representing the flare region. The peak at the time of flight t5 also appears in both a histogram H3e obtained by accumulating the third histogram and a histogram H4e obtained by accumulating the fourth histogram.

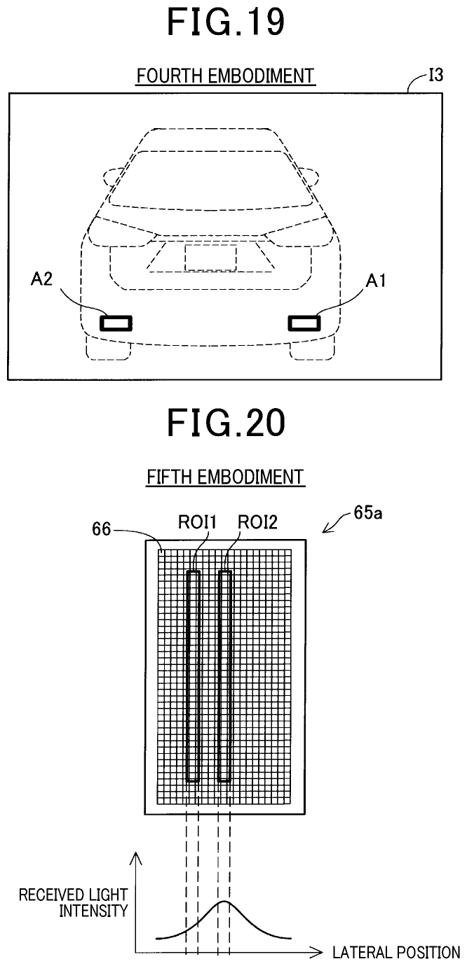

Of the distance images illustrated by the distances calculated from these histograms, as shown in FIG. 19, the first distance image is generated as an image 13 in which distances (reflective objects) are present only in two regions A1 and A2 corresponding to the two reflectors Rf1 and Rf2. As for the second distance image, a distance image including the two flares FL1 and FL2 such as an image 12 shown in FIG. 16 is generated.

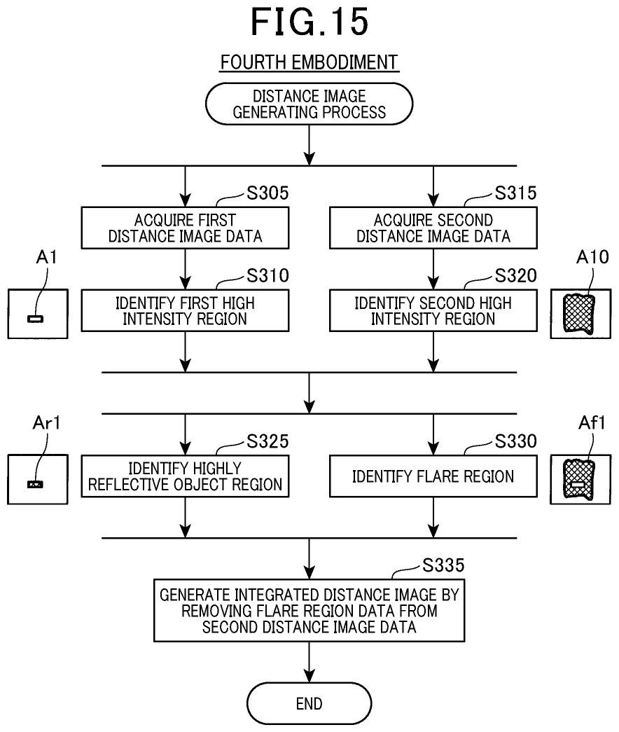

As shown in FIG. 15, the distance image generating part 520 acquires the first distance image data (step S305). Since step S305 is the same as step S205 shown in FIG. 8, it will not be described in detail. However, in the fourth embodiment, not only the distance of each pixel position but also the received light intensity is acquired as the first distance image data. The distance image generating part 520 identifies a region in which the received light intensity is equal to or higher than the threshold intensity in the first distance image acquired in step S305 (hereinafter referred to as a “high intensity region”) (step S310). The high intensity region identified in step S310 is referred to as a first high intensity region. Further, the threshold intensity used to identify the first high intensity region is also referred to as a first threshold intensity. In the case the first distance image shown in FIG. 19 is obtained, the two regions A1 and A2 are identified as the first high intensity regions. Note that, in FIG. 15, one of the two identified first high intensity regions A1 and

A2, the first high-intensity region A1, is shown to aid understanding. The distance image generating part 520 executes steps S315 and S320, which will be described later, in parallel with steps S305 and S310.

The distance image generating part 520 acquires second distance data (step S315). Since step S315 is the same as step S215 shown in FIG. 8, it will not be described in detail. However, in the fourth embodiment, not only the distance of each pixel position but also the received light intensity is acquired as the second distance image data. The distance image generating part 520 identifies a high intensity region in the second distance image acquired in step S315 (step S320). The high intensity region identified in step S320 is referred to as a second high intensity region. Further, the threshold intensity used to identify the second high intensity region is also referred to as a second threshold intensity. For example, when an image such as an image 12 shown in FIG. 16 is obtained as the second distance image, two regions corresponding to the two reflectors Rf1 and Rf2 as well as the two flares FL1 and FL2 are identified as the second high intensity regions. Note that, in FIG. 15, of the two regions corresponding to the two reflectors Rf1 and Rf2 and the two flares FL1 and FL2, the second high intensity region A10 corresponding to the reflector Rf1 and the flare FL1 is shown to aid understanding.

The distance image generating part 520 uses the first high intensity regions identified in step S310 and the second high intensity regions identified in step S330 to determine a region of an object having a very high reflectance in the second distance image (hereinafter referred to as a “highly reflective object region”) (step S325). Specifically, a region of each second high intensity region identified in step S320 that is at the same position as the first high intensity region identified in step S310 is identified as the highly reflective object region. In FIG. 15, a highly reflective object region Ar1 is shown to aid understanding. This highly reflective object region Ar1 is a highly reflective object region identified as a region of the high intensity region A10 that is at the same position as the high intensity region A1.

In parallel with step S325 described above, the distance image generating part 520 uses the first high intensity regions identified in step S310 and the second high intensity regions identified in step S320 to identify the regions corresponding to flares (hereinafter referred to as “flare regions”) in the second distance image (step S330). Specifically, the region of each of the second high intensity regions identified in step S320 excluding the first high intensity region identified in step S310 is identified as the flare region. In FIG. 15, a flare region Af1 is shown to aid understanding. This flare region Af1 is a flare region identified as the region of the high intensity region A10 excluding the high intensity region A1.

The distance image generating part 520 generates an integrated distance image by deleting the data on the flare regions from the second distance image data (step S335). By deleting the data on the flare regions, that is, the distance and received light intensity data of the pixel positions in the flare regions, the data on the portions whose distances were calculated with low accuracy due to the influence of the flares FL1 and FL2 is deleted, which prevents the low-accuracy distance data from remaining in the distance image.

The rangefinder 10 of the fourth embodiment described above provides effects similar to those of the rangefinder 10 of the first embodiment. In addition, a region of each second high intensity region in the second distance image excluding the region corresponding to the first high intensity region is identified as a flare region, and an image obtained by excluding the flare regions from the second distance image is generated as the integrated distance image. This makes it possible to suppress the inclusion of the regions (pixels) whose positions and distances were determined less accurately due to the flares in the integrated distance image.

### E. Fifth Embodiment

The device configuration of the rangefinder 10 of a fifth embodiment differs from the device configuration of the rangefinder 10 of the first embodiment in that the light receiving part 60 of the former includes a light receiving array 65a shown in FIG. 20 instead of the light receiving array 65. Since the rest of the configuration of the rangefinder 10 of the fifth embodiment is the same as that of the rangefinder 10 of the first embodiment, the same components are assigned with the same reference signs and will not be described in detail.

As shown in FIG. 20, the light receiving array 65a of the fifth embodiment has a larger number of pixels 66 in the lateral direction (horizontal direction) than the light receiving array 65 of the first embodiment shown in FIG. 2. The lower part of FIG. 20 shows an example of the received light intensity for each lateral position (horizontal position) of the pixels 66 constituting the light receiving array 65a. In the present embodiment, the angle of the mirror 54 of the scanning part 50 is controlled so that the closer the lateral position of a pixel of the light receiving array 65a is to the center, the greater the received light intensity.

In the fifth embodiment, when a histogram is generated, the histogram is generated not by using all the pixels 66 of the light receiving array 65a but only a partial pixel group. In other words, in the fifth embodiment, the received light intensity is determined only in a subregion of the light receiving part 60. The region of the light receiving part 60 in which the received light intensity is determined is referred to as a “region of interest (ROI)”. In the fifth embodiment, the two regions (a first region of interest ROI1 and a second region of interest ROI2) shown in FIG. 20 may be set as the regions of interest. The first region of interest ROI1 is a region including a pixel column consisting of a plurality of pixels 66 adjacent in the longitudinal direction (vertical direction) that is offset from the lateral center of the light receiving array 65a towards an edge thereof. On the other hand, the second region of interest ROI2 is a region including a pixel column consisting of a plurality of pixels 66 adjacent in the longitudinal direction (vertical direction) passing through the lateral center of the light receiving array 65a. The two regions of interest ROI1 and ROI2 have the same number of pixels 66. However, due to the difference in lateral position described above, even when they receive reflected rays of light of the same pulsed light, the received light intensity determined in the second region of interest ROI2 is greater than the received light intensity determined in the first region ROI1.

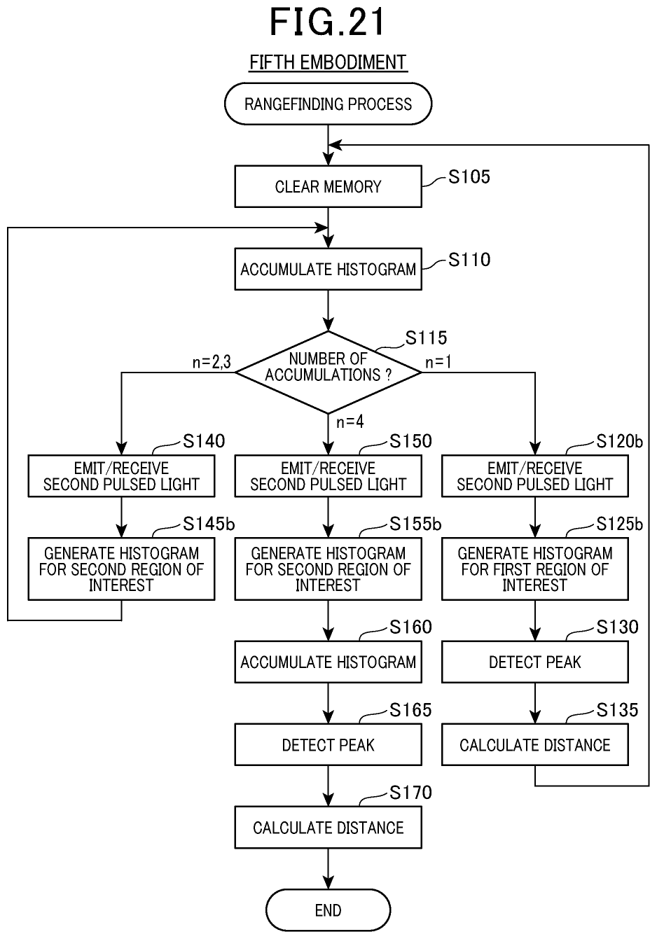

The rangefinding process of the fifth embodiment shown in FIG. 21 is different from the rangefinding process of the first embodiment shown in FIG. 5 in that step S120b is performed instead of step S120, step S145b is performed instead of step S145, and step S150b is performed instead of step S150. Since the other procedures of the rangefinding process of the fifth embodiment are the same as those of the first embodiment, the same procedures are assigned with the same reference signs and will not be described in detail.

When the number of accumulations is determined to be the first time in step S115, the control part 270 controls the light emitting part 40 so that it emits the second pulsed light, and causes the light receiving part 60 to receive light (step S120b). In contrast to step S120 of the first embodiment in which the first pulsed light is emitted, in step S120b of the fifth embodiment, the second pulsed light, that is, pulsed light having a higher intensity is emitted instead of the first pulsed light. Therefore, in the fifth embodiment, the second pulsed light is emitted regardless of the number of accumulations. After completing step S120b, when the light receiving part 60 receives the reflected light, the addition part 220 adds up the outputs of the SPAD circuits 68 included in the first region of interest ROI1, and the histogram generating part 230 generates a histogram for each pixel in the first region of interest ROI1. The histogram generating part 230 stores the generated histogram in the memory 260 and also outputs it to the peak detecting part 240 (step S125b). As described above, the received light intensity determined in the first region of interest ROD is small. Therefore, as in the first embodiment, a histogram generated in step S125b does not have a peak corresponding to the reflected light (clutter) of the window 92.

When the number of accumulations is determined to be the second or third time in step S115, the above-described step S140 is performed, and then the histogram of the second region of interest ROI2 is generated (step S145b). As described above, the received light intensity determined in the second region of interest ROI2 is large. Therefore, as in the first embodiment, a histogram generated in step S145b has a peak corresponding to the reflected light (clutter) of the window 92.

When the number of accumulations is determined to be the fourth time in step S115, the above-described step S150 is executed, and then a histogram of the second region of interest ROI2 is generated (step S155b). The histogram generated at this time has a peak corresponding to the reflected light (clutter) of the window 92 as with the histogram generated in step S145b described above. After completing step S155b, the above-described step S160 is performed.

The rangefinder 10 of the fifth embodiment described above provides effects similar to those of the rangefinder 10 of the first embodiment. In addition, the region for which a histogram is generated, in other words, the region in which the received light intensity is determined is changed according to the number of accumulations so that the intensity of the pulsed light is not changed. This provides effects such as suppressing the deterioration of the light emitting part 40 over time due to the intensity of emitted light being frequently changed, and eliminating the need for complicated processing in the control part 270.

### F. Sixth Embodiment

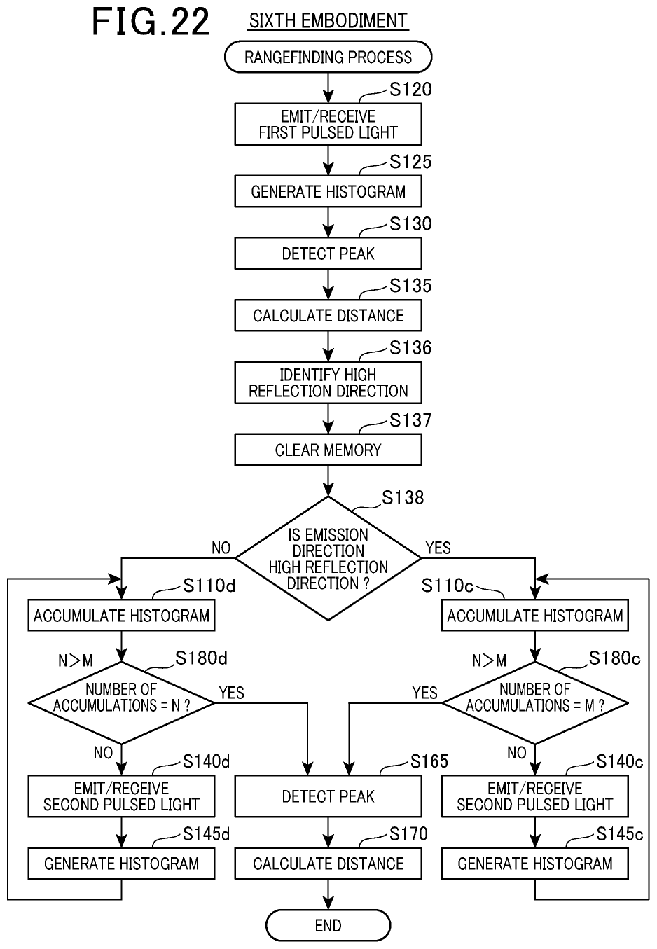

Since the device configuration of the rangefinder 10 of the sixth embodiment is the same as that of the first embodiment, the same components are assigned with the same reference signs and will not be described in detail. In the rangefinding process of the sixth embodiment shown in FIG. 22, procedures that are the same as those of the rangefinding process of the first embodiment shown in FIG. 5 are assigned with the same reference signs and will not be described in detail.

As shown in FIG. 22, in the rangefinding process of the sixth embodiment, first, the above-described steps S120 to S135 are executed. That is, the emission of the first pulsed light and the reception of the reflected light, the histogram generation, the peak detection, and the distance calculation are performed. After completing step S135, the control part 270 determines a high reflection direction. The “high reflection direction” refers to the direction of a region of a predetermined size including an object having a reflectance higher than a predetermined value (hereinafter referred to as a “high reflectance object”), and it is a direction relative to the rangefinder 10. A high reflectance object is estimated to be located at a position from which a time of flight Tf is recorded corresponding to a received light intensity larger than a predetermined value in the corresponding histogram generated in step S125. In step S136, the direction in which the region of the predetermined size including this high reflectance object is present is determined. Specifically, in the example of the fourth embodiment, the directions of the flares FL1 and FL2 generated as a result of the pulsed light being reflected off the reflectors Rf1 and Rf2 are determined. The size of the flare generated around a high reflectance object is obtained as a function of the size of the high reflectance object in advance based on experiments, simulations, or the like. In step S135, the high reflection direction is determined as the direction of a region corresponding to the size of such a flare. After completing step S136, the control part 270 clears the memory 260 (step S137).

The control part 270 determines whether the emission direction of the second pulsed light planned to be emitted thereafter corresponds to the high reflection direction (step S138). As described above, the laser beam is steered, and the control part 270 determines whether the emission direction at the timing at which the next pulsed light (second pulsed light) is emitted is the high reflection direction determined in step S136.

When it is determined that the emission direction of the second pulsed light does not correspond to the high reflection direction (step S138: NO), the histogram generating part 230 generates a histogram for each pixel, stores it in the memory 260, and also outputs it to the peak detecting part 240 (step S110d). This procedure of step S110d is the same as that of step S110 described above. The control part 270 determines whether the number of histogram accumulations has reached N (step S180d). “N” in step S180d is a positive integer larger than “M” described later. In the present embodiment, N is “3”. That is, in step S180d, it is determined whether the number of histogram accumulations has reached 3.

When it is determined that the number of histogram accumulations has not reached N (3) (step S180d: NO), the second pulsed light is emitted and the reflected light is received (step S140d), and a histogram is generated (step S145d). The procedures of these steps S140d and S145d are the same as those of steps S140 and S145 described above. After completing step S145d, the process returns to step S110d.

On the other hand, when it is determined that the number of histogram accumulations has reached N (3) (step S180d: YES), the above-described steps S165 and S170 are performed and the process ends. That is, a peak is detected based on the histogram obtained after a total of three accumulations, and then the distance is calculated. Therefore, when the above-described steps S110d, S180d, S140d, and S145d are performed, the second pulsed light is emitted a total of three times as in the first embodiment, and the distance is determined based on the histogram accumulated through the receptions of light corresponding to the three emissions.

In step S138 described above, when it is determined that the emission direction of the second pulsed light corresponds to the high reflection direction (step S138: YES), the histogram generating part 230 generates a histogram of each pixel, stores it in the memory 260, and also outputs it to the peak detecting part 240 (step S110c). This procedure of step S110c is the same as those of steps S110 and S110d. The control part 270 determines whether the number of histogram accumulations has reached M (step S180c). “M” in step S180c is a positive integer smaller than the above-mentioned “N”. In the present embodiment, M is “2”. That is, in step S180c, it is determined whether the number of histogram accumulations has reached 2.

When it is determined that the number of histogram accumulations has not reached N (2) (step S180c: NO), the second pulsed light is emitted and the reflected light is received (step S140c), and a histogram is generated (step S145c). The procedures of these steps S140c and S145c are the same as those of steps S140 and S145 described above. After completing step S145c, the process returns to step S110c.

On the other hand, when it is determined that the number of histogram accumulations has reached N (2) (step S180c: YES), the above-described steps S165 and S170 are executed. That is, a peak is detected based on the histogram obtained as a result of a total of two accumulations, and the distance is calculated. Therefore, when the above-described steps S110c, S180c, S140c, and S145c are executed, unlike in the first embodiment, the second pulsed light is emitted twice in total, and the distance is calculated based on the histogram accumulated through the receptions of light corresponding to the two emissions.

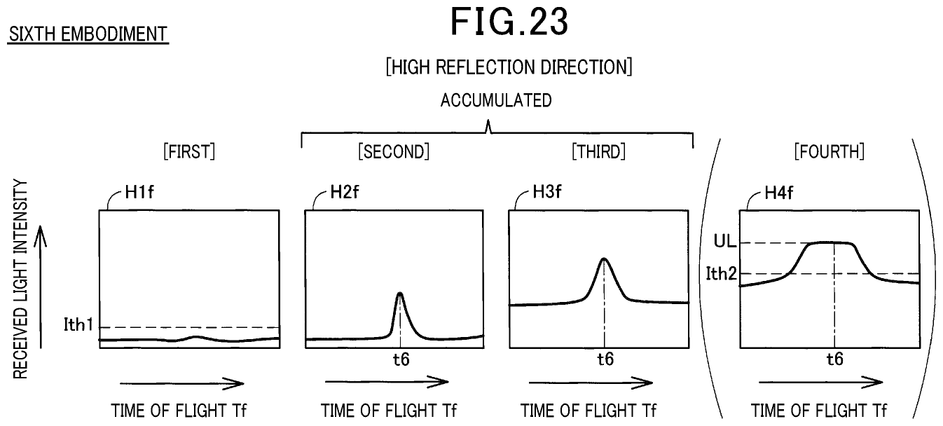

The reason why the number of times histograms corresponding to the second pulsed light are accumulated is changed depending on whether the emission direction corresponds to the high reflection direction in the sixth embodiment as described above will be described with reference to FIG. 23.

FIG. 23 shows how the histogram changes when pulsed light is emitted for the first time (the first pulsed light), for the second and third times (the second pulsed light), and further for the fourth time (the second pulsed light) in a case where the emission direction is the high reflection direction.

As with the first embodiment, at every time of flight, the second histogram H2f has a higher received light intensity than the first histogram H1f, and the third histogram H3f has an even higher received light intensity. The first to third histograms H1f to H3f have a peak at the time of flight t6. However, in the fourth histogram H4f, the received light intensity is excessively large at times of flight near the time of flight t6, and exceeds an upper limit UL of the range of received light intensities the light receiving part 60 can measure. Therefore, if a peak is detected based on the histogram H4f, the detection accuracy would be low. However, in the present embodiment, in the high reflection direction, the second pulsed light is emitted twice, that is, pulsed light is emitted a total of three times including the emission of the first pulsed light, and the peak is detected from the result of accumulation of the histograms corresponding to the second pulsed beams of the second and third emissions. Therefore, since the peak is detected from the histogram H3f in which the received light intensity is not saturated, it is possible to suppress the decrease in the accuracy of detection of the distance to the reflective object.

According to the rangefinder 10 of the sixth embodiment described above, effects similar to the rangefinder 10 of the first embodiment can be obtained. In addition, when the emission direction is the high reflection direction, the peak is detected based on a histogram obtained through less accumulations than the histograms used for directions other than the high reflection direction. This makes it possible to detect the peak based on a histogram in the state before the received light intensity is saturated. As a result, the decrease in the accuracy of detection of the distance to the reflective object can be suppressed. On the other hand, when the emission direction is not the high reflection direction, the peak is detected based on a histogram obtained through more accumulations than the histogram used for the high reflection direction. This makes it possible to detect the peak based on a histogram in a state where the peak is more prominent, and the decrease in the accuracy of detection of the distance to the reflective object can be suppressed in this case as well. The numbers of accumulations M and N are not limited to 2 and 3, and they can be any numbers satisfying N>M. Further, the sixth embodiment may be applied to the second embodiment. That is, it is also possible to accumulate histograms less times when the emission direction is the high reflection direction than when it is another direction in the configuration in which the received light intensity of the reflected light of the first pulsed light and the received light intensity of the reflected light of the second pulsed light are both accumulated.

### G. Seventh Embodiment

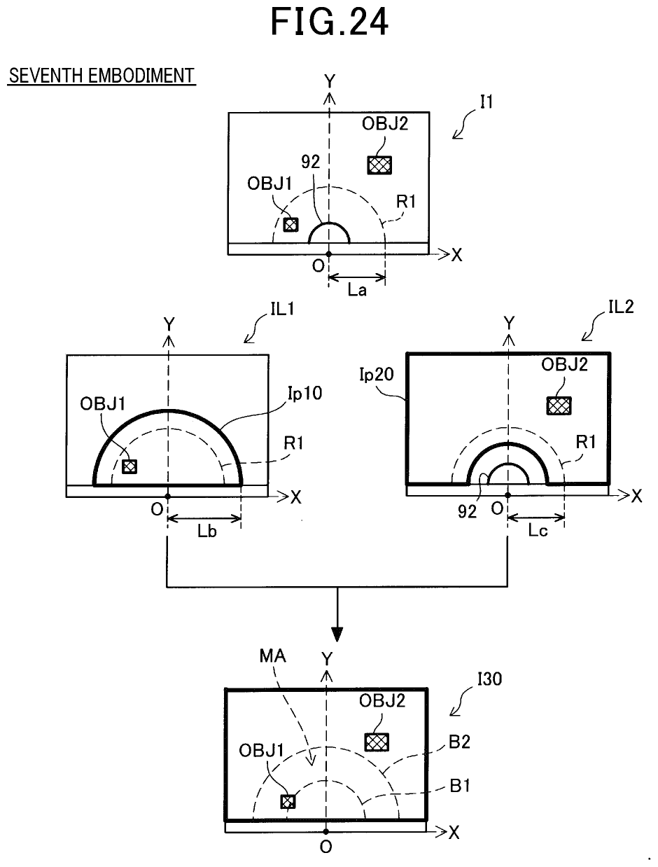

Since the device configuration of the rangefinder 10 of the seventh embodiment is the same as that of the first embodiment, the same components are assigned with the same reference signs and will not be described in detail. The top, middle, and bottom rows of FIG. 24 correspond to the top, middle, and bottom rows of FIG. 9, respectively. In the first embodiment, the first partial image Ip1 and the second partial image Ip2 did not overlap with each other. On the other hand, in the seventh embodiment, a first partial image Ip10 and a second partial image Ip20 overlap with each other. In FIG. 24, for reference, the region R1 of FIG. 9 is indicated by a broken line. In the seventh embodiment, each partial image contains not only information on the distance but also information on the received light intensity of each pixel position.

As shown in the left drawing in the middle row of FIG. 24, in the seventh embodiment, a distance image of the region within a radius of a first threshold distance Lb of the rangefinder 10 is cut out from a first distance image IL1 as the first partial image Ip10. Further, as shown in the right drawing in the middle row of FIG. 24, a distance image of a region consisting of the region outside a radius of a second threshold distance Lc of the rangefinder 10 and the boundary arc with a radius of the second threshold distance Lc and centered at the rangefinder 10 is cut out from the second distance image IL2 as the second partial image Ip20. These two partial images Ip10 and Ip20 are combined to generate an integrated distance image 130. The first threshold distance Lb is larger than the threshold distance La of the first embodiment. On the other hand, the second threshold distance Lc is smaller than the threshold distance La. That is, the first threshold distance Lb is larger than the second threshold distance Lc. As a result, there is an overlapping region MA between the first and second partial images Ip10 and Ip20 (hereinafter referred to as an “overlapping region”).

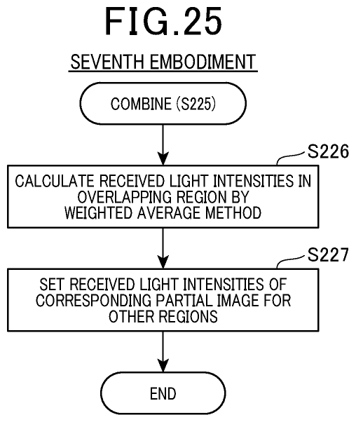

As shown in FIG. 25, in step S225 of the distance image generating process of the seventh embodiment, in addition to combining the first and second partial images as in the first embodiment, two steps S226 and S227 are included. In step S226, the distance image generating part 520 calculates the received light intensities of the overlapping region MA by finding weighted average values of the received light intensities of the two partial images Ip10 and Ip20. Specifically, for each position (pixel) in the overlapping region MA, the corresponding received light intensities of the partial images are each multiplied by a weight and then added together to obtain the average value. The weights are determined so that, the closer the position is to a radially-inner boundary B1 of the overlapping region MA, the greater the influence of the received light intensity of the first partial image Ip10 and the smaller the influence of the received light intensity of the second partial image Ip20. In other words, an average value is obtained by multiplying the corresponding received light intensities of the partial images by weights that are determined so that, the closer the position is to a radially-outer boundary B2 of the overlapping region MA, the smaller the influence of the received light intensity of the first partial image Ip10 and the greater the influence of the received light intensity of the second partial image Ip20, and then adding them together.

As shown in FIG. 25, in step S227, the distance image generating part 520 sets the received light intensity for each position (pixel) in the regions other than the overlapping region MA by selectively using the received light intensity of the first partial image Ip10 or that of the second partial image Ip20.

According to the rangefinder 10 of the seventh embodiment described above, effects similar to those of the rangefinder 10 of the first embodiment can be obtained. In addition, since the first threshold distance Lb is larger than the second threshold distance Lc, the first and second partial images Ip10 and Ip20 can overlap with each other to have an overlapping region MA. This makes it possible to eliminate a region that does not belong to either the first partial image Ip10 or the second partial image Ip20, and in turn to eliminate positions (pixels) for which the distance and received light intensity are not calculated. Further, for each position (pixel) in the overlapping region MA, the corresponding received light intensities of the partial images are each multiplied by a weight that is determined so that, the closer the position is to the radially-inner boundary B1 of the overlapping region MA, the greater the influence of the received light intensity of the first partial image Ip10 and the smaller the influence of the received light intensity of the second partial image Ip20. Therefore, for example, in a situation where a single object in the overlapping region MA gradually moves away, it is possible to prevent the distance and received light intensity of the object from changing excessively, and in turn to prevent erroneous recognition of an object or a decrease in the accuracy of detection of the distance to the object.

### H. Eighth Embodiment

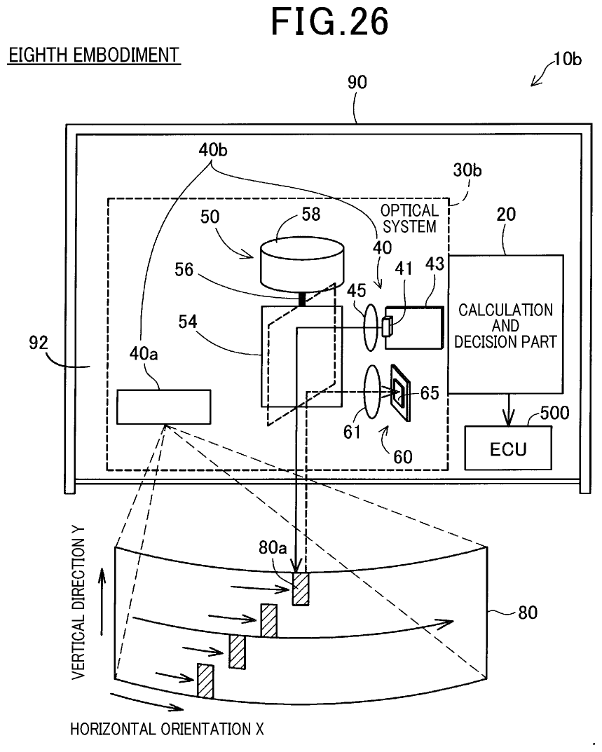

A rangefinder 10b of the eighth embodiment shown in FIG. 26 is different from the rangefinder 10 of the first embodiment shown in 1 in that the former includes, as the light emitting part 40b, a first light emitting part 40 corresponding to the light emitting part 40 of the first embodiment and a second light emitting part 40a. Since the rest of the configuration of the rangefinder 10b of the eighth embodiment is the same as that of the rangefinder 10 of the first embodiment, the same components are assigned with the same reference signs and will not be described in detail. Since the configuration of the first light emitting part 40 is the same as that of the light emitting part 40 of the first embodiment, they are assigned with the same reference signs and will not be described in detail.

The second light emitting part 40b irradiates the entire scan area of the laser beam, that is, the field-of-view area 80 at once (surface emission). In the present embodiment, the second light emitting part 40b includes a VCEL (Vertical Cavity Surface Emitting Laser) and an optical system for diffusing the laser light output from the VCEL.

As operation modes, the light emitting part 40b has an operation mode (hereinafter referred to as a “first emission mode”) for steering the pulsed light while it is being emitted from the first light emitting part 40 as in the first embodiment, and an operation mode (hereinafter referred to as a “second emission mode”) for irradiating the entire field-of-view area 80 at once with the pulsed light from the second light emitting part 40a.

The control part 270 emits the first pulsed light in the second emission mode and emits the second pulsed light in the first emission mode. Therefore, in step S120 shown in FIG. 5, the first pulsed light is emitted from the second light emitting part 40a, and in steps S140 and S150, the second pulsed light is emitted from the first light emitting part 40.

According to the rangefinder 10 of the eighth embodiment described above, effects similar to those of the rangefinder 10 of the first embodiment can be obtained. In addition, since the second light emitting part 40a that irradiates the field-of-view area 80 at once (surface emission) emits the first pulsed light having a relatively low intensity, the amount of light output from the VCEL can be suppressed, which contributes to power saving. A region 80a that can be irradiated by the first light emitting part 40 at once in the first emission mode corresponds to a “first irradiated region” of the present disclosure. Further, the field-of-view area 80, which is a region that can be irradiated by the second light emitting part 40a at once in the second irradiation mode, corresponds to a “second irradiated region” of the present disclosure. The phrase “relatively low intensity” means that the intensity per unit area of light incident on the light receiving surface is relatively low, not the intensity of light emitted by the laser element 41. Similarly, the phrase “relatively high intensity” means that the intensity per unit area of light incident on the light receiving surface is relatively high.

### I. Other Embodiments

### I1. First Alternative Embodiment

In the first to fourth embodiments, two types of pulsed light, namely, the first pulsed light having a relatively low intensity and the second pulsed light having a relatively high intensity, are emitted, but the present disclosure is not limited to this. Similarly to the fifth embodiment, the first pulsed light may be omitted and only the second pulsed light may be emitted four times. However, this alternative embodiment having such a configuration may be different from the fifth embodiment in that the sensitivity of the light receiving part 60 to received light is low during a certain period of time in which pulsed light is emitted for the first time and the reflected light thereof is received, and the sensitivity of the light receiving part 60 to received light is high during a period of time in which pulsed light is emitted for the second to fourth times and the reflected light thereof is received. The sensitivity of the light receiving part 60 to received light can be realized, for example, by adjusting the voltage supplied to the avalanche diodes Da. Specifically, the sensitivity to received light can be increased by increasing the voltage of the power supply Vcc, and the sensitivity to received light can be decreased by decreasing the voltage of the power supply Vcc. During the period of time corresponding to the first emission of pulsed light, the sensitivity of the light receiving part 60 to received light is adjusted to a level at which the light receiving part 60 does not detect clutter. Further, during the period of time corresponding to the second to fourth emissions of pulsed light, the sensitivity is adjusted so that, when the second pulsed light is emitted, the reflected light from a reflective object (external object) within a predetermined distance of the rangefinder 10 causes a predetermined number or more of the SPAD circuits 68 constituting each pixel 66 to operate, and has a received light intensity equal to or higher than a predetermined received light intensity. As a result of such control, a histogram in which the received light intensity at each time of flight has a relatively small S/N ratio is obtained by the first emission of pulsed light, and histograms in which the received light intensity at each time of flight has a relatively large S/N ratio is obtained by the second to fourth emissions of pulsed light. Therefore, effects similar to those of the other embodiments can be obtained. In such a configuration, the histogram obtained by the first emission of pulsed light corresponds to the first received light intensities of the present disclosure. Further, the histograms obtained by the second to fourth emissions of pulsed light corresponds to a second received light intensity of the present disclosure. The emission of the first pulsed light and the second pulsed light may be combined with the adjustment of the sensitivity of the light receiving part 60.

As can be understood from this first alternative embodiment and the other embodiments, a configuration may be applied to the rangefinder of the present disclosure that controls at least one of the intensity of the pulsed light emitted from the light emitting part 40, the sensitivity of the light receiving part 60 to received light, and the position of the region of interest on the light receiving part 60 so that, in response to the first emission of pulsed light, a received light intensity (first received light intensity) having a relatively small S/N ratio is obtained as the received light intensity for each of a plurality of times of flight, and, in response to the second to fourth emissions of pulsed light, a received light intensity (second received light intensity) having a S/N ratio higher than that of the first received light intensity is obtained as the received light intensity for each of a plurality of times of flight.

### I2. Second Alternative Embodiment

In the first to third embodiments, the first pulsed light is emitted the first-time pulsed light is emitted, and the second pulsed light is emitted the second to fourth times pulsed light is emitted. However, the present disclosure is not limited to this. The first pulsed light may be only emitted the fourth-time pulsed light is emitted, and the second pulsed light may be emitted the first to third times pulsed light is emitted. Further, for example, the second pulsed light may be emitted the first, third-, and fourth-times pulsed light is emitted, and the first pulsed light may be emitted the second-time pulsed light is emitted. Further, the second pulsed light may be emitted once, three times, or more. The first pulsed light may be emitted more than once. In such a configuration, the histograms obtained a plurality of emissions of the first pulsed light may be accumulated into a histogram used to find the peak (first distance image).

Similarly, in the first alternative embodiment, the sensitivity to received light may be increased during the period of time in which the pulsed light is emitted for the first to third times and the reflected light thereof is received, and the sensitivity to received light may be decreased during the period of time in which the pulsed light is emitted for the fourth time and the reflected light thereof is received. Alternatively, the sensitivity to received light may be increased during the period of time in which the pulsed light is emitted for the first, third, and fourth times and the reflected light thereof is received, and the sensitivity to received light may be decreased during the period of time in which the pulsed light is emitted for the second time and the reflected light thereof is received. The sensitivity to received light may be increased for one emission. The sensitivity to received light may be decreased for more than one emission.

As can be understood from this second alternative embodiment and the other embodiments, a configuration may be applied to the rangefinder of the present disclosure that controls at least one of the intensity of the pulsed light emitted from the light emitting part 40 and the sensitivity of the light receiving part 60 to received light so that, in response to at least one of the plurality of emissions of pulsed light, a received light intensity (first received light intensity) having a relatively small S/N ratio is obtained as the received light intensity for each of a plurality of times of flight, and, in response to at least one of the plurality of emissions of pulsed light, a received light intensity (second received light intensity) having a S/N ratio higher than that of the first received light intensity is obtained as the received light intensity for each of a plurality of times of flight.

### I3. Third Alternative Embodiment

The configurations of the rangefinders 10 and 10a of the embodiments are merely examples and can be changed in various ways. For example, although the distance image generating part 520 is provided in the ECU 500 different from the calculation and decision part 20, it may be provided in the calculation and decision part 20 instead of the ECU 500. Further, for example, in the fourth embodiment, even when the rangefinder 10 does not have a window, for example, even when the calculation and decision part 20, the optical system 30, and the like are housed in a casing in which only an opening is formed, certain effects can be obtained. Further, for example, although the rangefinders 10 and 10a are vehicle-mounted LiDARs, they may be applied to any moving body such as a ship or an airplane instead of a vehicle. Alternatively, they may be installed as a fixed device for security or any other purpose.

### I4. Fourth Alternative Embodiment

In the above embodiments, the distance image generating process may be omitted. Such a configuration can also determine the measurement target distance for each pixel by performing the rangefinding process. Further, in such a configuration, instead of determining the measurement target distance of every pixel in the field-of-view area 80, only the measurement target distance of a single pixel may be determined. In this configuration as well, as in the other embodiments, one of the first distance based on the first received light intensity and the second distance based on the second light receiving distance is determined as the measurement target distance of the pixel.

### I5. Fifth Alternative Embodiment

The control part 270, the calculating part 200, the distance image generating part 520, and their methods described herein may be realized by a dedicated computer provided by configuring a processor and a memory programmed to execute one or more functions embodied by computer programs. Alternatively, the control part 270, the calculating part 200, the distance image generating part 520, and their methods described herein may be realized by a dedicated computer provided by configuring a processor with one or more dedicated hardware logic circuits. Alternatively, the control part 270, the calculating part 200, the distance image generating part 520, and their methods described herein may be realized by one or more dedicated computers configured by combining a processor and a memory programmed to execute one or more functions with a processor configured with one or more hardware logic circuits. The computer programs may be stored in a computer-readable, non-transitional tangible recording medium as instructions executed by the computer.

### I6. Sixth Alternative Embodiment

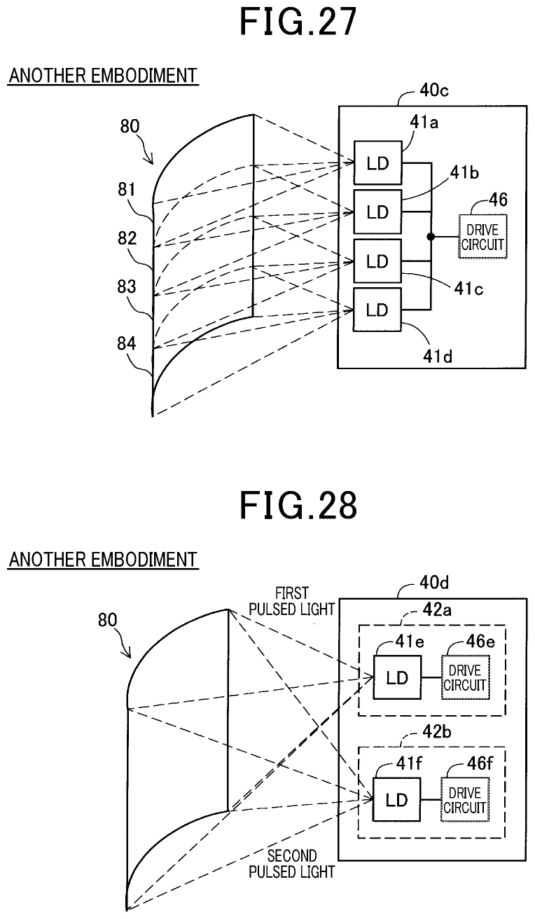

The configurations of the laser element and its drive circuit of the above embodiments are merely examples and can be modified in various ways. For example, in the example of a light emitting part 40c shown in FIG. 27, four laser elements 41a, 41b, 41c, and 41d and one drive circuit 46 are provided. The four laser elements 41a to 41d irradiate different parts of the field-of-view area 80 with pulsed light. Specifically, the laser element 41a irradiates the top row of the field-of-view area 80 divided into four equal parts in the vertical direction with pulsed light. The laser element 41b irradiates the area of the second row from the top with pulsed light. The laser element 41c irradiates the area of the third row from the top with pulsed light. The laser element 41d irradiates the area of the fourth row from the top with pulsed light. The drive circuit 46 is connected to the four laser elements 41a to 41d, and outputs the identical signals to these four laser elements 41a to 41d at the same time. As a result, in the example of FIG. 27, the four laser elements 41a to 41d simultaneously emit pulsed beams in horizontally the same directions.

Further, for example, a light emitting part 40d shown in FIG. 28 includes a weak light emitting part 42a and a normal light emitting part 42b. The weak light emitting part 42a includes a laser element 41e and a drive element 46e thereof. The normal light emitting part 42b includes a laser element 41f and a drive element 46f thereof. The weak light emitting part 42a scans and irradiates the entire field-of-view area 80 with the first pulsed light. The normal light emitting part 42b scans and irradiates the entire field-of-view area 80 with the second pulsed light.

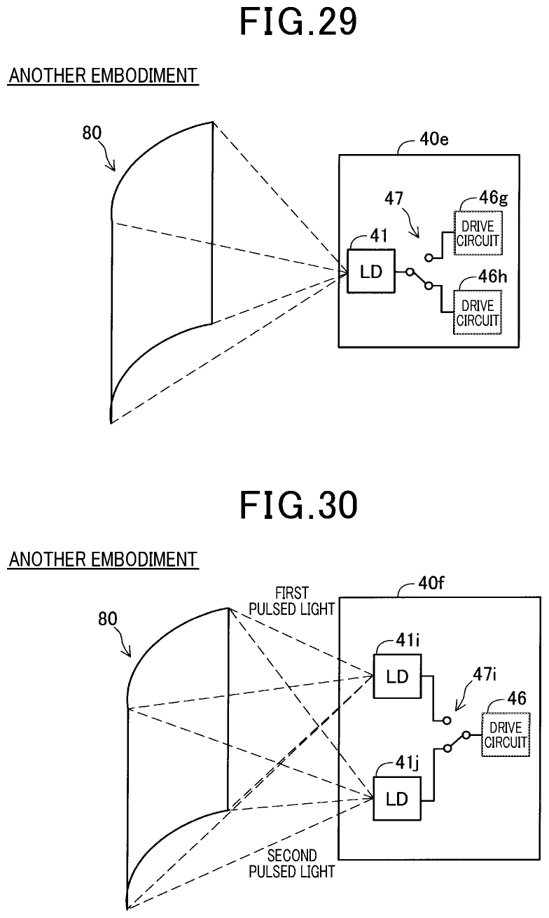

Further, for example, a light emitting part 40e shown in FIG. 29 includes one laser element 41, two drive circuits 46g and 46h, and a line selector 47. The drive circuit 46g is a drive circuit for causing the light emitting part to emit the first pulsed light. The drive circuit 46h is a drive circuit for causing the light emitting part to emit the second pulsed light. The line selector 47 selectively connects one of the two drive circuits 46g and 46h to the laser element 41. The line selector 47 switches the connection according to a command from the control part 270.

Further, for example, a light emitting part 40f shown in FIG. 30 includes two laser elements 41i and 41j, one drive circuit 46, and a line selector 47i. The laser element 41i is a laser element for emitting the first pulsed light. The laser element 41j is a laser element for emitting the second pulsed light. The line selector 47i selectively connects one of the two laser elements 41i and 41j to the drive circuit 46. The line selector 47i switches the connection according to a command from the control part 270. These configurations also provide effects similar to those of the other embodiments.

### I7. Seventh Alternative Embodiment

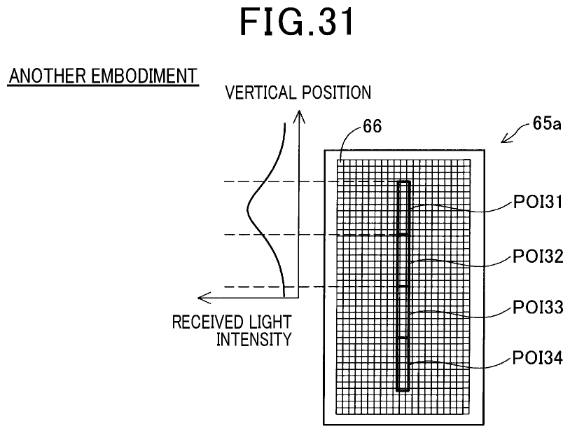

In the fifth embodiment, to change the region for which histograms are generated, in other words, the region in which the received light intensities are determined according to the number of accumulations, the region of interest is selectively changed between the lateral center and a position laterally offset from the center. However, the present disclosure is not limited to this. In the example of FIG. 31, four regions of interest ROI31, ROI32, ROI33, and ROI34 having the same vertical length are set at the lateral center of the light receiving array 65a. Further, in this example, the rangefinder 10 includes a light emitting part having the same configuration as the light emitting part 40c shown in FIG. 27. However, the four laser elements 41a to 41d irradiate areas having different lateral positions with pulsed light at the same time. Further, in this example, none of the four laser elements 41a to 41d emits the first pulsed light, and they only emit the second pulsed light. For example, when pulsed light is emitted for the second to fourth times in the first embodiment, a histogram is generated for only the pixel group of, of the four regions of interest P0131 to P0134, the region of interest corresponding to the position irradiated with the pulsed light. For example, when the region corresponding to the region of interest POI 31 is irradiated with pulsed light, as shown in FIG. 31, the vertical position at which the received light intensity peak appears corresponds to the position of the region of interest POI 31. On the other hand, when pulsed light is emitted for the first time in the first embodiment, a histogram is generated only for the pixel group of the region of interest adjacent to the region of interest corresponding to the position irradiated with the pulsed light. For example, when the region corresponding to the region of interest POI 31 is irradiated with the pulsed light as described above, a histogram is generated only for the pixel group of the region of interest POI 32 adjacent to the region of interest POI 31. As shown in FIG. 31, the region of interest adjacent to the region of interest corresponding to the position irradiated with the pulsed light is offset from the peak, and the received light intensity is low. Therefore, effects similar to those provided when the first pulsed light is emitted can be obtained.

### I8. Eighth Alternative Embodiment

In the above-described embodiments, the integrated distance image of the entire field-of-view area 80 is generated, but the present disclosure is not limited to this. For example, a distance image may be generated representing a unit area within a predetermined angular range (predetermined directional range) in the horizontal direction. Further, for example, in the fourth embodiment, the determination of the first high intensity region and the second high intensity region, and the determination of the highly reflective object region and the flare region can be carried out in a unit area within a predetermined angular range (predetermined directional range) in the horizontal direction.

### I9. Ninth Alternative Embodiment

In the above-described embodiments, a total of two types of pulsed light, namely, the first pulsed light and the second pulsed light having different intensities, are emitted, but the present disclosure is not limited to this. Three or more types of pulsed light having different intensities may be emitted. In the fourth embodiment, the distances from the rangefinder 10 to the reflectors Rf1 and Rf2 may change depending on the position of the vehicle Cl. When the distances from the rangefinder 10 to the reflectors Rf1 and Rf2 change, the intensity of the reflected light from the first high intensity regions A1 and A2 may also change. Therefore, depending on the position of the vehicle Cl, it may not be possible to identify the first high intensity regions A1 and A2 using the first pulsed light. However, as described above, by emitting three or more types of pulsed light having different intensities, the possibility of identifying the first high intensity regions A1 and A2 regardless of the position of the vehicle Cl can be increased.

### I10. Tenth Alternative Embodiment

In each embodiment, the ECU 500 is housed in the casing 90, but instead it may be placed outside the casing 90. This configuration also provides effects similar to those of the other embodiments.

### I11. Eleventh Alternative Embodiment

In the eighth embodiment, the first light emitting part 40 may be omitted, and the pulsed light may be emitted only from the second light emitting part 40a. In such a configuration, the intensity of the output laser beam is controlled so that the second light emitting part 40a emits not only the first pulsed light but also the second pulsed light.

The present disclosure can also be implemented in various modes. For example, it can be implemented as a rangefinder system, a moving body equipped with a rangefinder, a rangefinding method, a computer program for implementing these devices and methods, a non-temporary recording medium storing such a computer program, or the like.

The present disclosure is not limited to the above embodiments, and can be implemented in various configurations without departing from the spirit of the present disclosure. For example, the technical features of the embodiments corresponding to the technical features of the modes described in “Summary of the Invention” may be replaced or combined as appropriate to solve part or all of the above-described problems, or achieve part or all of the above-described effects. When a technical feature is not described as an essential feature herein, it can be removed as appropriate.

What is claimed is:

1. A rangefinder comprising:
a light emitting part that emits pulsed light a plurality of times in each emission direction;
a light receiving part that receives reflected light of the pulsed light;
a calculating part that uses a time of flight of the reflected light received by the light receiving part to calculate a measurement target distance, which is a distance to a reflective object that reflects the pulsed light and outputs the reflected light; and
a control part that controls at least one of an intensity of the pulsed light emitted from the light receiving part, sensitivity of the light receiving part to the reflected light received, and a position of a region of interest on the light receiving part in which a received light intensity is determined, wherein
the calculating part includes:
a received light intensity determining part that determines a received light intensity for each of a plurality of times of flight,
a peak detecting part that detects a time of flight corresponding to a peak of the received light intensities of the plurality of times of flight,
a distance calculating part that calculates a distance from the detected time of flight corresponding to the peak, and
a distance determining part that uses the distance calculated by the distance calculating part to determine the measurement target distance, wherein
the control part controls at least one of an intensity of the pulsed light emitted from the light emitting part, the sensitivity of the light receiving part to the reflected light received, and the position of the region of interest so that the received light intensity determining part obtains, at least once in the plurality of times the pulsed light is emitted, a first received light intensity as the received light intensity of each of the plurality of times of flight, and the received light intensity determining part obtains, at least once in the plurality of times the pulsed light is emitted, a second received light intensity having an S/N ratio higher than that of the first received light intensity as the received light intensity of each of the plurality of times of flight, and
the distance determining part uses a first distance, which is the distance calculated based on the first received light intensity, and a second distance, which is the distance calculated based on the second received light intensity, to determine the measurement target distance.

2. The rangefinder according to claim 1, wherein
the control part causes the received light intensity determining part to obtain the first received light intensities by causing the light emitting part to emit first pulsed light, and causes the received light intensity determining part to obtain the second received light intensities by causing the light emitting part to emit second pulsed light having an intensity higher than an intensity of the first pulsed light.

3. The rangefinder according to claim 2, further comprising:
a casing that houses the light emitting part and the light receiving part and provided with a window that transmits the pulsed light and the reflected light, wherein
the intensity of the first pulsed light is at such a level that the light receiving part cannot recognize reception of the reflected light of the first pulsed light reflected off the window.

4. The rangefinder according to claim 1, wherein
the sensitivity of the light receiving part to received light can be adjusted, and
the control part causes the received light intensity determining part to obtain the first received light intensities by decreasing the sensitivity to received light, and causes the received light intensity determining part to obtain the second received light intensities by increasing the sensitivity to received light.

5. The rangefinder according to claim 1, further comprising:
a distance image generating part that generates a distance image, which is an image showing a position and the measurement target distance of the reflective object, wherein
the distance image generating part combines a first distance image including the first distance determined for each emission direction and a second distance image including the second distance determined for each emission direction to generate an integrated distance image.

6. The rangefinder according to claim 3, further comprising:
a distance image generating part that generates a distance image, which is an image showing a position and the measurement target distance of the reflective object, wherein
the distance image generating part combines a first distance image including the first distance determined for each emission direction and a second distance image including the second distance determined for each emission direction to generate an integrated distance image.

7. The rangefinder according to claim 5, further comprising:
a first storage part that stores the time of flight corresponding to a maximum received light intensity, and a second storage part that stores a histogram showing the received light intensity for each of the plurality of times of flight, wherein
in response to the received light intensity determining part sequentially determining the first received light intensities of the plurality of times of flight, the received light intensity determining part updates and stores a time of flight corresponding to a higher received light intensity in the first storage part, and
the received light intensity determining part sequentially determines the second received light intensities of the plurality of times of flight, and creates the histogram and stores the created histogram in the second storage part, wherein
the peak detecting part detects the time of flight stored in the first storage part as a first time of flight, which is the time of flight of the peak, and detects a second time of flight, which is a time of flight of the peak, from a histogram obtained by accumulating the histogram stored in the second storage part, and
the distance image generating part generates the first distance image using the first distance calculated based on the first time of flight, and
the distance image generating part generates the second distance image using the second distance calculated based on the second time of flight.

8. The rangefinder according to claim 6, wherein
the distance image generating part combines:
a first partial image of the first distance image that shows a position of and a distance to the reflective object within a threshold distance of the rangefinder, and
a second partial image of the second distance image that shows a position of and a distance to the reflective object at a distance larger than the threshold distance from the rangefinder,
to generate the integrated distance image.

9. The rangefinder according to claim 8, wherein
the received light intensity determining part has a histogram generating part that creates a histogram representing the received light intensity for each of a plurality of times of flight, and
the peak detecting part determines a range of times of flight at which the received light intensities are higher than an intensity threshold value in the histogram, and detects a time of flight of a peak of the received light intensities within the determined range.

10. The rangefinder according to claim 9, further comprising:
a storage part that stores the received light intensities of the plurality of times of flight,
wherein the light emitting part emits the first pulsed light as a first emission of the pulsed light, and emits the second pulsed light as a second and subsequent one or more emissions of the pulsed light,
the histogram generating part stores a received light intensity obtained within a predetermined period of time including a time of flight of the reflected light corresponding to the first pulsed light of the first emission in the storage part and generates the histogram, and clears the storage part when the peak detecting part detects a first time of flight, which is a time of flight of the peak, using the histogram, and
the histogram generating part generates the histogram by accumulating a received light intensity obtained within the predetermined period of time including a time of flight of the reflected light corresponding to the second pulsed light one after another each time the second pulsed light is emitted from the second emission to a last emission, and storing an accumulated received light intensity in the storage part, and clears the storage part when the peak detecting part detects a second time of flight, which is a time of flight of the peak, using the histogram, and
the distance image generating part generates the first distance image using the first distance calculated based on the first time of flight, and
the distance image generating part generates the second distance image using the second distance calculated based on the second time of flight.

11. The rangefinder according to claim 9, further comprising:
a storage part that stores the received light intensities of the plurality of times of flight, wherein
the light emitting part emits the first pulsed light as a first emission of the pulsed light, and emits the second pulsed light from a second emission to a last emission of the pulsed light,
the histogram generating part generates the histogram by accumulating a received light intensity obtained within a predetermined period of time including a time of flight of the reflected light corresponding to the pulsed light one after another each time the pulsed light is emitted from the first emission to the last emission, and storing an accumulated received light intensity in the storage part,
in response to the received light intensity obtained within the predetermined period of time including the time of flight of the reflected light corresponding to the first pulsed light of the first emission being stored in the storage part and the histogram being generated, the peak detecting part detects a first time of flight of the peak using the histogram, and
in response to the histogram being generated by accumulating a received light intensity obtained within the predetermined period of time including a time of flight of the reflected light corresponding to the first or second pulsed light one after another each time the first or second pulsed light is emitted from the first emission to the last emission, and storing an accumulated received light intensity in the storage part, the peak detecting part detects a second time of flight of the peak using the histogram, and
the distance image generating part generates the first distance image using the first distance calculated based on the first time of flight, and
the distance image generating part generates the second distance image using the second distance calculated based on the second time of flight.

12. The rangefinder according to claim 5, wherein
the distance image generating part identifies, in the first distance image, a first high intensity region in which the received light intensity is equal to or higher than a first threshold intensity,
the distance image generating part identifies, in the second distance image, a second high intensity region in which the received light intensity is equal to or higher than a second threshold intensity,
the distance image generating part identifies a region of the second high intensity region of the second distance image excluding a region corresponding to the first high intensity region as a flare region, which is a region representing a flare, and
the distance image generating part acquires an image obtained by excluding the flare region from the second distance image as the integrated distance image.

13. The rangefinder according to claim 10, wherein
after emission of the first pulsed light as the first emission and before emission of the second pulsed light as the second emission, the control part uses the first distance calculated based on the first time of flight to determine a high reflection direction, which is a direction relative to the rangefinder of a region of a predetermined size including a high reflectance object whose reflectance is higher than a predetermined value, and
for a direction that is not the high reflection orientation, the histogram generating part generates the histogram by accumulating a received light intensity obtained within the predetermined period of time including a time of flight of the reflected light corresponding to the second pulsed light one after another each time the second pulsed light is emitted from the second emission to the last emission, and storing an accumulated received light intensity in the storage part, and
for the high reflection direction, the histogram generating part generates the histogram by accumulating a received light intensity obtained within the predetermined period of time including a time of flight of the reflected light corresponding to the second pulsed light one after another each time the second pulsed light is emitted the second emission to a particular emission before the last emission, and storing an accumulated received light intensity in the storage part.

14. The rangefinder according to claim 11, wherein
after emission of the first pulsed light as the first emission and before emission of the second pulsed light as the second emission, the control part uses the first distance calculated based on the first time of flight to determine a high reflection direction, which is a direction relative to the rangefinder of a region of a predetermined size including a high reflectance object whose reflectance is higher than a predetermined value, and
for a direction that is not the high reflection direction, in response to the histogram being generated by accumulating a received light intensity obtained within the predetermined period of time including a time of flight of the reflected light corresponding to the first or second pulsed light one after another each time the first or second pulsed light is emitted from the first emission to the last emission, and storing an accumulated received light intensity in the storage part, the histogram generating part detects a second time of flight of the peak using the histogram, and
for the high reflection direction, in response to the histogram being generated by accumulating a received light intensity obtained within the predetermined period of time including a time of flight of the reflected light corresponding to the first or second pulsed light one after another each time the first or second pulsed light is emitted from the first emission to a particular emission before the last emission, and storing an accumulated received light intensity in the storage part, the histogram generating part detects a second time of flight of the peak using the histogram.

15. The rangefinder according to claim 6, wherein,
the distance image generating part combines a first partial image of the first distance image that shows a position of and a distance to the reflective object within a first threshold distance of the rangefinder, and
the distance image generating part combines a second partial image of the second distance image that shows a position of and a distance to the reflective object at distance that is larger than a second threshold distance from the rangefinder,
to generate the integrated distance image, and
the first threshold distance is larger than the second threshold distance.

16. The rangefinder according to claim 2, wherein
the light emitting part has a first emission mode in which a first irradiated region having a predetermined size is scanned and irradiated with the second pulsed light, and a second emission mode in which a second irradiated region corresponding to a scan area of the first emission mode is irradiated with the first pulsed light, and
the control part causes the light emitting part to emit the first pulsed light by operating the light emitting part in the second emission mode, and causes the light emitting part to emit the second pulsed light by operating the light emitting part in the first emission mode.
